(19) United States
(12) Patent Application Publication
(10) Pub. No.: US 2004/0210932 A1
(43) Pub. Date: Oct. 21, 2004

(54) Program preselecting/recording apparatus for searching an electronic program guide for programs according to predetermined search criteria

(76) Inventors: Toshiaki Mori, Minoo-shi (JP); Noboru Katta, Itami-shi (JP); Hirotsugu Kawata, Sakai-shi (JP); Toshihiko Kurosaki, Kobe-shi (JP); Yoshiaki Kushiki, Katano-shi (JP)

Correspondence Address: SNELL & WILMER LLP, 1920 MAIN STREET, SUITE 1200, IRVINE, CA, 92614-7230, US

(21) Appl. No.: 10/827,781

(22) Filed: Apr. 20, 2004

Related U.S. Application Data
(62) Division of application No. 09/434,060, filed on Nov. 4, 1999, now abandoned.

(30) Foreign Application Priority Data
Nov. 5, 1998 (JP) 10-314263
Dec. 9, 1998 (JP) 10-350080
Feb. 4, 1999 (JP) 11-27580

(51) Int. Cl. G06F 3/00; H04N 5/445; G06F 13/00; H04N 5/91; H04N 7/00

(52) U.S. Cl. 725/39

(57) ABSTRACT

A program preselecting apparatus is provided. An electronic program guide storing unit stores an electronic program guide made up of a plurality of sets of program information of a plurality of programs, each of the plurality of sets of program information including a time slot, channel number, and content information of a respective program. A preselection criteria storing unit stores a plurality of preselection criteria used for specifying programs to be preselected, each of the plurality of preselection criteria including at least one criterion item which specifies at least the content information. A searching unit searches, according to each of the plurality of preselection criteria, the electronic program guide for a program corresponding to each set of program information that satisfies the criterion items of the preselection criterion. An overlap judging unit judges whether there are programs whose time slots overlap among programs found as a result of the search by the searching unit. A choosing unit chooses, when there are the programs whose time slots overlap, one of the programs with the overlapping time slots. A preselecting unit preselects the chosen program by storing a time slot and channel number of the chosen program.

This application is based on applications Nos. 10-314263, 10-350080, and 11-027580 filed in Japan, the contents of which are hereby incorporated by reference.

### BACKGROUND OF THE INVENTION

1. Field of the Invention

The present invention relates to a program preselecting apparatus and a program recording apparatus, and in particular relates to a technique for searching an electronic program guide for programs, a technique for generating search criteria, and a technique for managing conditions for deleting recorded programs.

2. Description of the Prior Art

Recent years have seen the commencement of the electronic program guide distribution service that transmits TV program data with electronic program guide data superimposed thereon. The electronic program guide data is received at the receiving end and the electronic program guide is displayed on a TV screen. By browsing the displayed electronic program guide, the user can choose programs to watch or to record.

FIG. 1 shows an example of the electronic program guide displayed on the TV screen.

The user moves a cursor on the display shown in the figure using a remote control or the like and chooses a program he or she wants to view or record.

Here, the electronic program guide data may contain information on the contents of each program such as a genre and people appearing in the program. In this case, based on preselection criteria set beforehand according to the user's favorite genres or celebrities, it is possible to automatically find programs that seem to be preferred by the user and preselect the programs for recording.

An automatic recording timer apparatus disclosed in Japanese Laid-Open Patent Application 7-121935 automatically preselects programs for recording which satisfy user-defined criteria, through a search on an electronic program guide.

Also, even when the user has not define his/her favorite genres or celebrities, this apparatus automatically preselects programs for recording which seem to be preferred by the user, based on information about programs viewed by the user in the past.

An automatic preselection storing apparatus and method disclosed in Japanese Laid-Open Patent Application 10-228687 stores information about programs viewed by the user in the past week. If a program is scheduled in the same time slot as a program viewed by the user a week ago and belongs to the same genre as the viewed program, the program is automatically recorded. Further, if a program belongs to the same genre as a program viewed by the user in the past week, the program is automatically recorded regardless of its time slot.

A program recording apparatus disclosed in Akio Yanagimachi et al. (1997) “Toward Next-Generation Digital Broadcasting” (in the Journal of the Institute of Image Information and Television Engineers vol. 1.51, no. 9, pp.1370˜1379) holds a user profile that shows preferences of the user, and automatically records a program whose program information matches any of the user preferences in the user profile.

However, when two or more programs to record are scheduled in the same time period and one of the programs has to be chosen, the above conventional techniques cannot automatically judge which of the programs should be chosen for recording and so relies on the user for making a choice. The user who prefers automatic recording must find making such a choice troublesome and may not bother to do anything about it, as a result of which none of the programs will be recorded during the time period.

Also, given a limited storage capacity of a storing unit for recording programs, if the storing unit is full, programs recorded in the storing unit must be deleted before recording new programs.

Therefore, each time the user intends to record a new program, he or she is required to decide which recorded program(s) should be deleted from the storing unit and how large space should be secured for recording the new program. The user who prefers automatic recording must find such a requirement troublesome and may not bother to do anything about it, as a result of which the new program cannot be recorded.

### SUMMARY OF THE INVENTION

In view of the above problems, the present invention aims to provide a program preselecting apparatus for automatically preselecting, when two or more programs to view or record are scheduled in the same time period, one of the programs without requiring involvement by the user, a program recording apparatus for automatically deleting one or more recorded programs to create available recording space in a storing unit without requiring involvement by the user, and storing mediums storing programs for executing the above program preselection and program recording.

The above object can be fulfilled by a broadcast program preselecting apparatus, including: an electronic program guide storing unit for storing an electronic program guide that is made up of a plurality of sets of program information of a plurality of programs, each of the plurality of sets of program information including a broadcast time slot of a respective program, a channel number on which the program will be broadcasted, and content information relating to a content of the program; a preselection criteria storing unit for storing a plurality of preselection criteria used for specifying programs to be preselected, each of the plurality of preselection criteria including at least one criterion item which specifies at least the content information; a searching unit for searching, according to each of the plurality of preselection criteria, the electronic program guide for a program corresponding to each set of program information that satisfies the criterion items of the preselection criterion; an overlap judging unit for judging whether there are programs whose broadcast time slots overlap among programs found as a result of the search by the searching unit; a choosing unit for choosing, when the overlap judging unit judges that there are the programs whose broadcast time slots overlap, one of the programs with the overlapping broadcast time slots; and a preselecting unit for preselecting the chosen program by storing a broadcast time slot and a channel number of the chosen program.

With this construction, if time slots of programs found as a result of the search overlap, one of the programs is automatically chosen and preselected.

Accordingly, the user does not have to manually determine which of the programs with the overlapping time slots should be preselected to view or record.

The above object can also be fulfilled by a broadcast program recording apparatus for receiving programs to be recorded and recording the received programs into a fixed storing unit, the broadcast program recording apparatus including: a time assigning unit for assigning, to a received program, a delete-protect time before which the program cannot be automatically deleted; a recording unit for recording the program to which the delete-protect time has been assigned, into the fixed storing unit; and an automatic deleting unit for automatically deleting the recorded program whose delete-protect time has been reached.

With this construction, a delete-protect time is set for each program to be recorded, so that it is possible to automatically delete recorded programs which have exceeded their delete-protect times.

Accordingly, the user does not have to manually determine which recorded programs should be deleted to secure sufficient space for recording new programs.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 shows an example of an electronic program guide displayed on a TV screen;

FIG. 2 is a block diagram showing the configuration of a program preselecting apparatus of the first embodiment of the present invention;

FIG. 3 shows an example of an automatic preselection table stored in an automatic preselection information storing unit 3 in the program preselecting apparatus;

FIG. 4 shows an example of electronic program guide data stored in an electronic program guide storing unit 5 in the program preselecting apparatus;

FIG. 5 shows an example of an electronic program guide displayed based on the electronic program guide data stored in the electronic program guide storing unit 5;

FIG. 6 shows an example of a preselected program table stored in a preselected program table storing unit 6 in the program preselecting apparatus;

FIG. 7 shows an example of a GUI display for setting each entry in the automatic preselection table;

FIG. 8 shows a remote control for operating the program preselecting apparatus;

FIG. 9 is a flowchart showing the program preselection procedure by a preselection managing unit 2 in the program preselecting apparatus;

FIG. 10 shows an example of a GUI display for changing priorities of sets of preselection information in the automatic preselection table;

FIG. 11 shows an example of a GUI display after the priorities of the sets of preselection information displayed on the GUI display in FIG. 10 have been changed;

FIG. 12 shows an example of an automatic preselection table stored in an automatic preselection information storing unit 3 in a program preselecting apparatus of the second embodiment of the present invention;

FIG. 13 is a flowchart showing a program preselection procedure by a preselection managing unit 2 in the program preselecting apparatus;

FIG. 14 is a diagrammatic sketch of the program preselection procedure shown in FIG. 13;

FIG. 15 is a flowchart showing another program preselection procedure by the preselection managing unit 2 in the program preselecting apparatus;

FIG. 16 is a diagrammatic sketch of the program preselection procedure shown in FIG. 15;

FIG. 17 is a diagrammatic sketch of the program preselection procedure shown in FIG. 15 where an alternative preselection entry of a set of preselection information based on which Program 3 has been searched for is set;

FIG. 18 shows an example of an automatic preselection table stored in an automatic preselection information storing unit 3 in a program preselecting apparatus of the third embodiment of the present invention;

FIG. 19 is a flowchart showing the program preselection procedure by a preselection managing unit 2 in the program preselecting apparatus;

FIG. 20 is a diagrammatic sketch of the program preselection procedure shown in FIG. 19;

FIG. 21 is another diagrammatic sketch of the program preselection procedure shown in FIG. 19;

FIG. 22 is a block diagram showing the configuration of a program preselecting apparatus of the fourth embodiment of the present invention;

FIG. 23 shows an example of preselected program history information stored in a preselected program history storing unit 23 in the program preselecting apparatus;

FIG. 24 shows an example of electronic program guide data stored in an electronic program guide storing unit 26 in the program preselecting apparatus;

FIG. 25 is a flowchart showing the procedure of generating automatic program preselection criteria;

FIG. 26 is a flowchart showing the detailed process of step S52 shown in FIG. 25;

FIG. 27 shows selection rates calculated for separate genres in step S52;

FIG. 28 is a flowchart showing the detailed process of step S53 shown in FIG. 25;

FIG. 29 shows a distribution of variety show programs in 24 hours of a day obtained in step S53;

FIG. 30 is a flowchart showing the detailed process of step S54 shown in FIG. 25;

FIG. 31 shows numbers of variety show programs counted for separate channel numbers in step S54;

FIG. 32 shows an example of automatic program preselection criteria generated by the automatic preselection criteria generating unit 24;

FIG. 33 shows an example of a part of electronic program guide data;

FIG. 34 shows the automatic program preselection criteria in FIG. 32 to which channel number priorities have been added;

FIG. 35 shows an example of a part of electronic program guide data for Saturday;

FIG. 36 is a flowchart showing the procedure of automatically adjusting the amount of programs to be recorded based on recording time remaining in a recording medium 34;

FIG. 37 shows the total broadcast time period of programs in a week ahead that satisfy an automatic program preselection criterion, for four automatic program preselection criteria of the first to fourth priorities;

FIG. 38 is a block diagram showing the configuration of a program preselecting apparatus of the fifth embodiment of the present invention;

FIG. 39 shows an example of a GUI display which presents information on programs recommended for preselection for recording;

FIG. 40 is a block diagram showing the configuration of a program recording apparatus of the seventh embodiment of the present invention;

FIG. 41 is a diagrammatic sketch of user information stored in a storing unit 104 in the program recording apparatus;

FIG. 42 is a block diagram showing the detailed configuration of a controlling unit 103 in the program recording apparatus;

FIG. 43 shows an example of a GUI display presenting a list of recorded programs;

FIG. 44 is a flowchart showing the automatic deletion procedure in automatic recording by a program recording/deletion managing unit 110 in the controlling unit 103;

FIG. 45 is a flowchart showing the procedure of rewriting user information;

FIG. 46 is a flowchart showing the procedure of setting search criteria by a program searching unit 109 in the controlling unit 103;

FIG. 47 shows an example of a GUI display showing search criteria;

FIG. 48 shows an example of a GUI display for adding priority parameters;

FIG. 49 shows an example of a GUI display showing the search criteria in FIG. 47 to which user-specified search criteria have been added; and

FIG. 50 shows an example of a GUI display presenting a list of delete candidate programs.

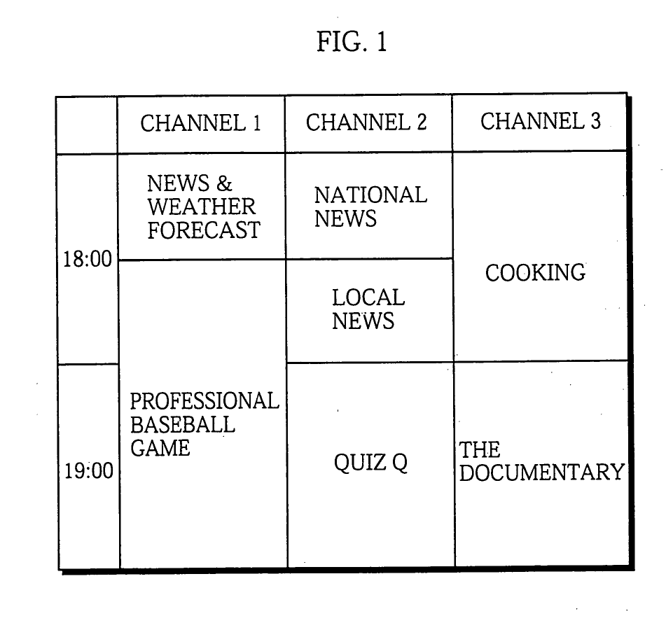

### DESCRIPTION OF THE PREFERRED EMBODIMENT(S)

### First Embodiment

A program preselecting apparatus of the first embodiment of the present invention searches for programs using prioritized sets of preselection information, and preselects a program searched for using a set of preselection information with the higher priority if time slots of the programs overlap. Note that in this specification the term preselection means selecting a program in advance to view or to record.

(Configuration)

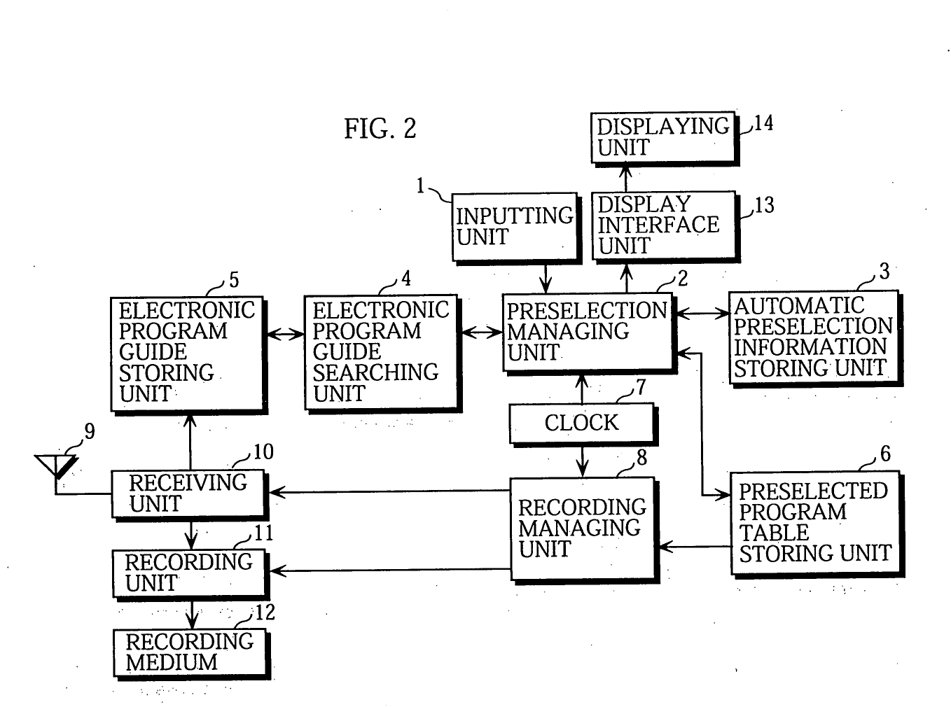

FIG. 2 shows the configuration of the program preselecting apparatus of the first embodiment.

This program preselecting apparatus is roughly made up of an inputting unit 1, a preselection managing unit 2, an automatic preselection information storing unit 3, an electronic program guide searching unit 4, an electronic program guide storing unit 5, a preselected program table storing unit 6, a clock 7, a recording managing unit 8, an antenna 9, a receiving unit 10, a recording unit 11, a recording medium 12, a display interface unit 13, and a displaying unit 14.

The inputting unit 1 is made up of switches of a remote control or front panel and receives user indications and user-specified sets of preselection information.

The preselection managing unit 2 manages the user-specified sets of preselection information. Through this preselection managing unit 2, the sets of preselection information received by the inputting unit 1 are stored into the automatic preselection information storing unit 3.

The automatic preselection information storing unit 3 receives the sets of preselection information from the preselection managing unit 2 and stores them in the form of an automatic preselection table.

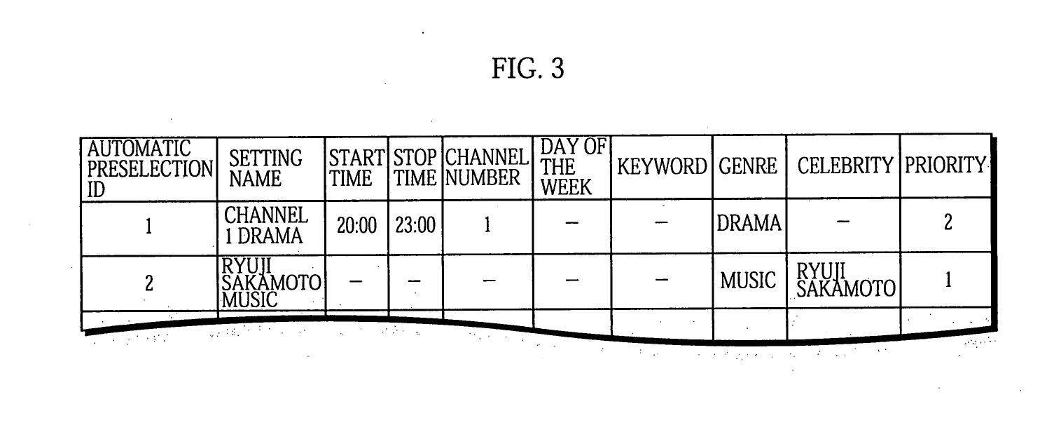

FIG. 3 shows an example of the automatic preselection table stored in the automatic preselection information storing unit 3.

This automatic preselection table has entries for automatic preselection ID, setting name, start time, stop time, channel number, day of the week, keyword, genre, celebrity, and priority. These entries are specified by the user apart from the automatic preselection ID.

The automatic preselection ID is an identifier which identifies a set of preselection information.

The setting name is a name given to the set of preselection information for the sake of convenience. The user is at liberty to set whatever name he or she finds convenient.

The keyword, the genre, and the celebrity are used as search keys for searching an electronic program guide. If the start time, the stop time, the channel number, and the day of the week are set in the table, the scope of a search is narrowed to certain parts of the electronic program guide which correspond to the set start time, stop time, channel number, and day of the week.

The priority is set to a unique value under management of the preselection managing unit 2. Here, a positive integer is used for the priority, with smaller values being given to higher priorities. The priority can be freely changed by the user.

The electronic program guide searching unit 4 searches the electronic program guide for programs that satisfy any of the sets of preselection information in the automatic preselection table stored in the automatic preselection information storing unit 3.

The electronic program guide storing unit 5 stores electronic program guide data received via the receiving unit 10.

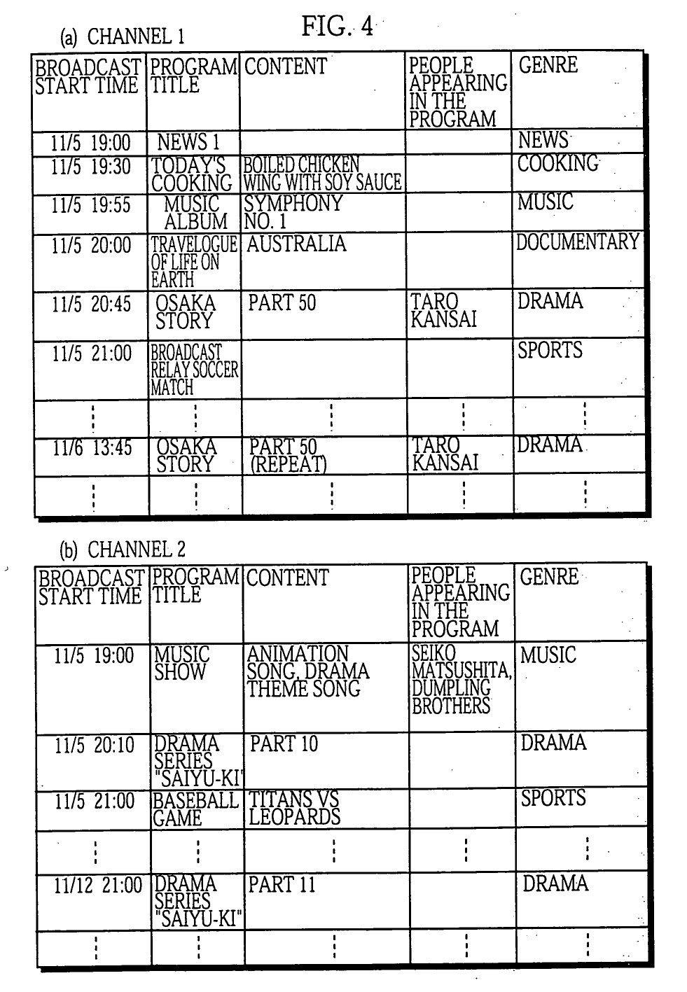

FIG. 4 shows an example of the electronic program guide data stored in the electronic program guide storing unit 5.

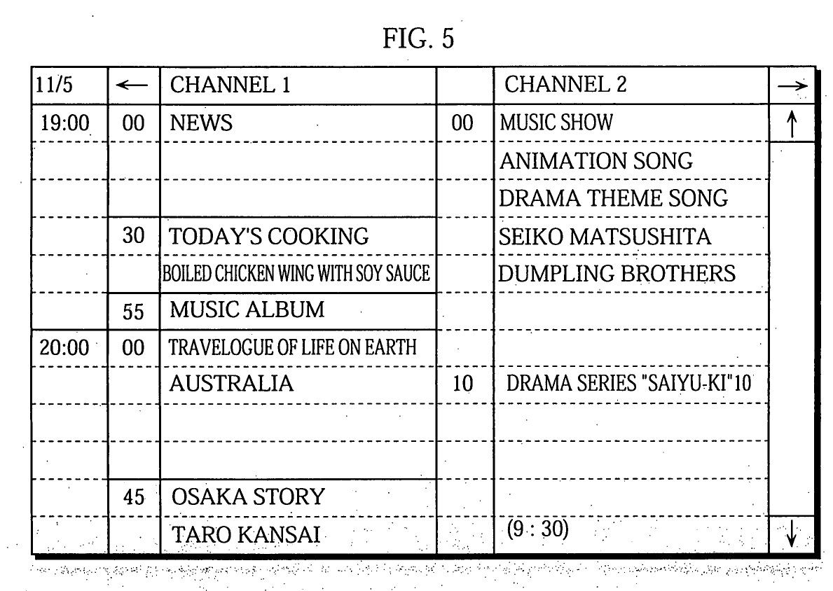

FIG. 5 shows an example of an electronic program guide displayed on the displaying unit 14 based on the electronic program guide data in FIG. 4.

The preselected program table storing unit 6 stores a preselected program table that contains information on a time slot and channel number of each preselected program.

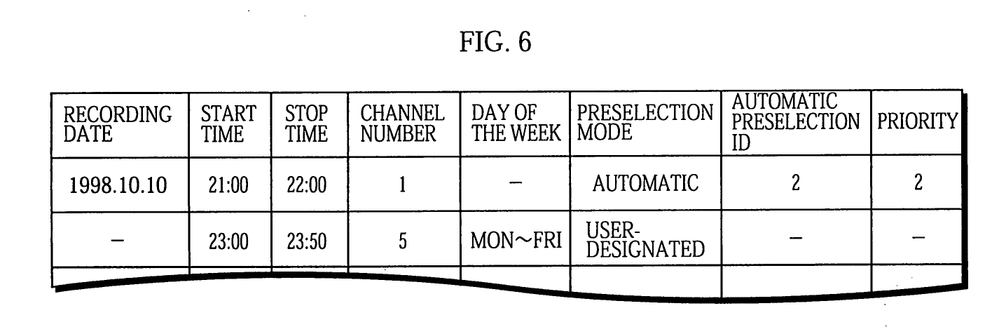

FIG. 6 shows an example of the preselected program table stored in the preselected program table storing unit 6.

This preselected program table has entries for recording date, start time, stop time, channel number, day of the week, preselection mode, automatic preselection ID, and priority. The start time, the stop time, the channel number, and either the recording date or the day of the week need to be specified to record a program. The preselection mode shows whether the program was manually preselected by the user or automatically preselected. The automatic preselection ID is an identifier identifying a set of preselection information based on which the program was retrieved, with the priority being set to be the same as a priority of the set of preselection information. In this embodiment all of the entries are set by the preselection managing unit 2.

The clock 7 outputs current date and time information.

The recording managing unit 8 controls the receiving unit 10 and recording unit 11 to record each preselected program, based on the preselected program table stored in the preselected program table storing unit 6 and the date and time information outputted from the clock 7.

The antenna 9 receives a carrier wave.

The receiving unit 10 receives the carrier wave bearing TV program data and electronic program guide data superimposed thereon, and outputs the TV program data and the electronic program guide data respectively to the recording unit 11 and the electronic program guide storing unit 5.

The recording unit 11 records the TV program data into the recording medium 12.

The recording medium 12 is a medium such as a hard disk for recording the TV program data.

The display interface unit 13 converts GUI (graphical user interface) display information of the electronic program guide or the like into signals suitable for display by the displaying unit 14.

The displaying unit 14 displays a GUI display for operating the program preselecting apparatus.

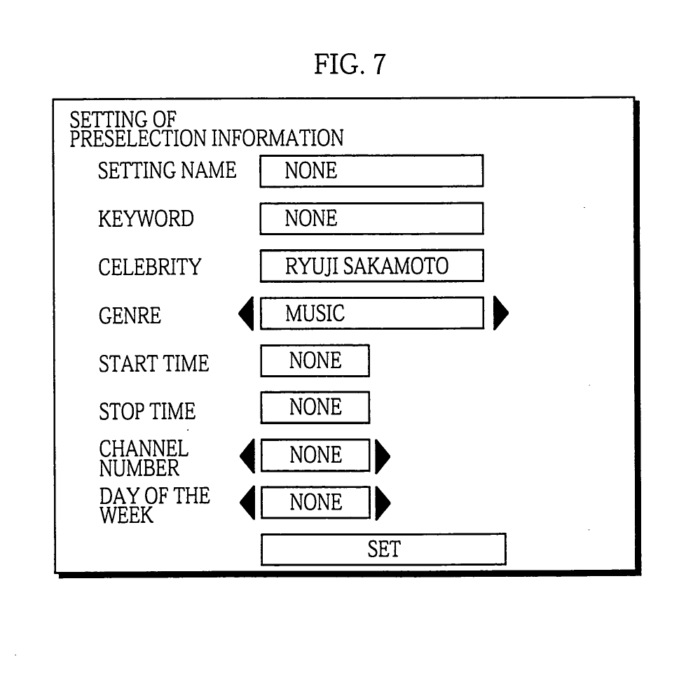

FIG. 7 shows an example of a GUI display for setting the entries of the automatic preselection table.

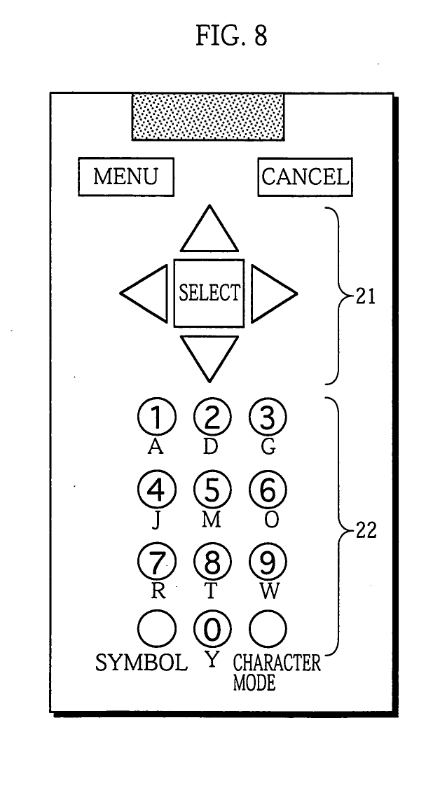

FIG. 8 shows the remote control for operating the program preselecting apparatus.

The user sets each entry of the automatic preselection table through the use of cursor keys 21 and character input keys 22 on the remote control.

The preselection managing unit 2 has the electronic program guide searching unit 4 search the electronic program guide for a program that satisfies each set of preselection information, when a new set of preselection information is registered in the automatic preselection information storing unit 3, when the electronic program guide is updated, or at regular time intervals. If time slots of programs retrieved as a result overlap, the preselection managing unit 2 chooses one of the programs in accordance with priorities of sets of preselection information based on which the programs were retrieved, and stores information necessary for recording the chosen program into the preselected program table storing unit 6.

On storing such information in the preselected program table storing unit 6, the preselection managing unit 2 writes “automatic” in the preselected program table as the preselection mode for the chosen program, and copies a priority given to a set of preselection information in the automatic preselection table based on which the program was retrieved, to the preselected program table as the priority for the program.

A program can also be manually preselected by the user through the inputting unit 1. In this case, the preselection managing unit 2 writes “user-designated” in the preselected program table as the preselection mode for the user preselected program, while leaving the priority entry of the program blank.

(Operation)

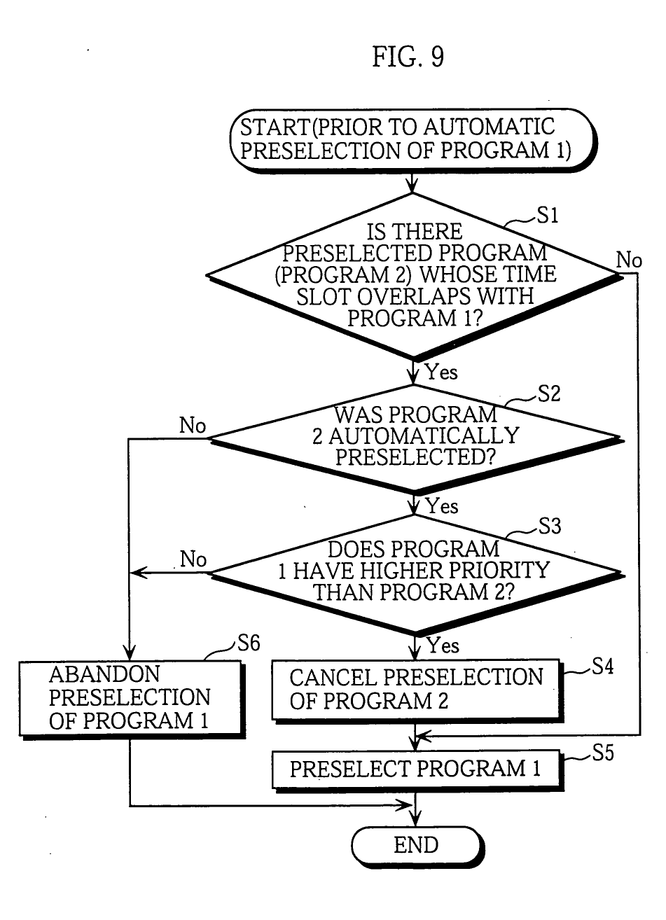

FIG. 9 is a flowchart showing the program preselection procedure of the preselection managing unit 2 in the program preselecting apparatus of the first embodiment. Suppose from the electronic program guide the electronic program guide searching unit 4 has retrieved Program 1 that satisfies a set of preselection information in the automatic preselection table stored in the automatic preselection information storing unit 3. Here, the program preselecting apparatus is unable to record more than one program simultaneously.

This being so, the program preselection procedure of the preselection managing unit 2 is as follows.

(1) Before preselecting Program 1, judge whether the preselected program table contains a program whose time slot overlaps a time slot of Program 1 (S1).

(2) If there is a preselected program (Program 2) whose time slot overlaps the time slot of Program 1, check the preselection mode of Program 2 in the preselected program table to judge whether Program 2 was automatically preselected (S2).

(3) If Program 2 was automatically preselected, compare the priority of the set of preselection information based on which Program 1 has been retrieved, with the priority corresponding to Program 2 in the preselected program table, thereby judging whether Program 1 has higher priority than Program 2 (S3).

(4) If Program 1 has higher priority than Program 2, cancel the preselection of Program 2 (S4).

(5) If there is no preselected program whose time slot overlaps the time slot of Program 1 in step S1 or if the preselection of Program 2 is canceled in step S4, preselect Program 1 to complete the procedure (S5).

(6) If Program 2 was not automatically preselected in step S2 or if Program 1 does not have higher priority than Program 2 in step S3, complete the procedure without preselecting Program 1 (S6).

The following is an explanation on how the user changes priorities of sets of preselection information in the automatic preselection table.

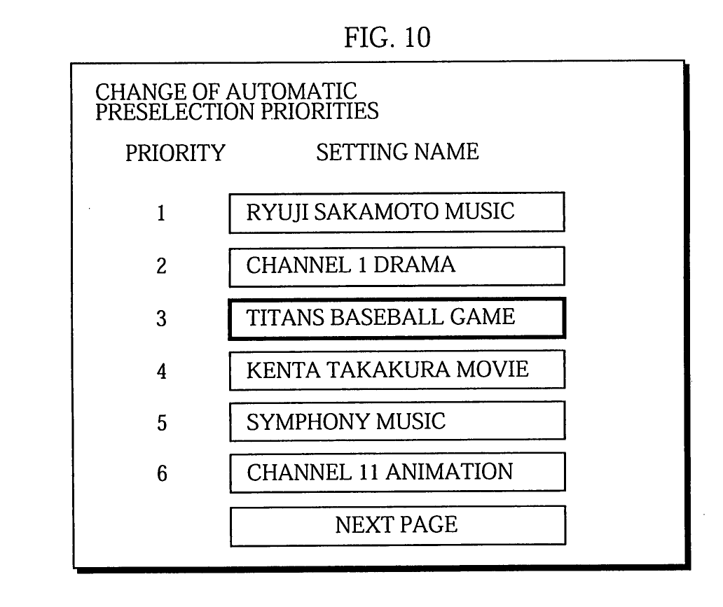

FIG. 10 shows an example of a GUI display for changing priorities of sets of preselection information in the automatic preselection table.

On this GUI display setting names are listed in order of descending precedence.

To make a change in the priorities, the user moves the cursor on the display to a setting name whose priority is to be changed using the “up” key or the “down” key on the remote control and presses the “select” key. The user then moves the setting name to a new priority position using the “up” key or the “down” key and presses the “select” key. For example, if the user wants to change the priority of the setting name “Titans Baseball Game” from “3” to “1”, pressing the “up” key or the “down” key on the remote control moves the cursor, stopping on the setting name “Titans Baseball Game” highlights the setting name, and pressing the “select” key chooses the highlighted name. After this, pressing the “up” key twice moves the setting name “Titans Baseball Game” to the first priority position and pressing the “select” key completes the change.

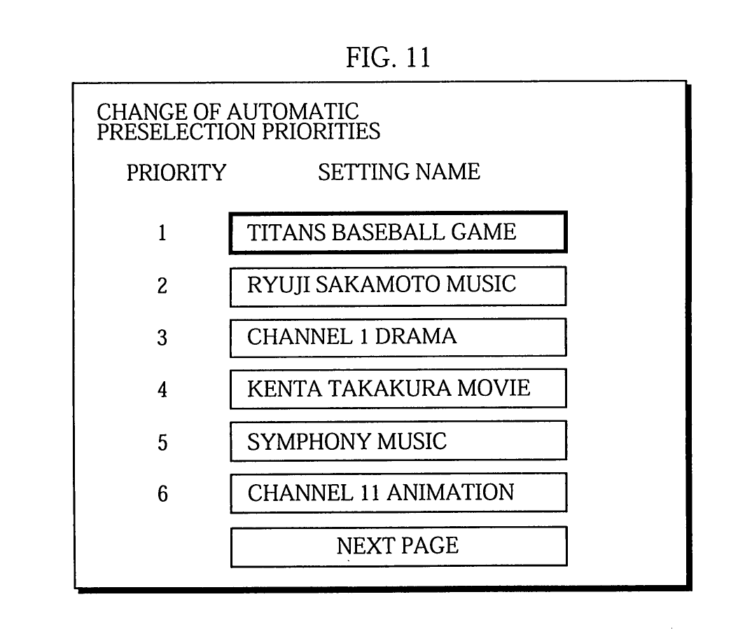

FIG. 11 shows an example of a GUI display displayed after the priorities of the sets of preselection information displayed on the GUI display in FIG. 10 have been changed.

On this GUI display the setting names are listed in order of descending precedence.

As a result of the above change, the priority of “Titans Baseball Game” has been altered from “3” to “1”, while the priorities of “Ryuji Sakamoto Music” and “Channel 1 Drama” have been altered from “1” and “2” to “2” and “3”, respectively.

Thus, when an overlap in time slot occurs between a program to be automatically preselected and an automatically preselected program, a program with higher priority is automatically chosen for recording in accordance with user-specified priorities. This saves the user from having to determine which of the programs with overlapping time slots should be recorded.

In the above embodiment priorities have been assigned to sets of preselection information included in the automatic preselection table. Instead, priorities may be assigned to separate entries independently of the automatic preselection table, wherein a priority of a certain entry is assigned to a set of preselection information containing the entry. Assume the first to third priorities have been given respectively to the genres “Variety Show”, “Baseball Game”, and “Drama”. Then if time slots of two or more programs retrieved from the electronic program guide overlap, a program which belongs to a genre with the highest priority among the retrieved programs is preselected. In so doing, a program of the user's favorite genre takes precedence over other programs in automatic preselection. Here, priorities may be assigned not only to separate entries but to combinations of entries.

### Second Embodiment

A program preselecting apparatus of the second embodiment of the present invention is different with the first embodiment in that its automatic preselection table includes an alternative preselection entry. Suppose a program is retrieved based on a set of preselection information whose alternative preselection is set and a time slot of the program overlaps a time slot of another retrieved program. Then the program preselecting apparatus of the second embodiment relaxes the set of preselection information in regard to time, searches for a program that is similar to the retrieved program and is scheduled in a time slot different from the other retrieved program, and preselects the program as an alternative to the originally retrieved program.

(Configuration)

The configuration of the program preselecting apparatus of the second embodiment is roughly the same as the first embodiment, so that the following explanation focuses on the differences with the first embodiment.

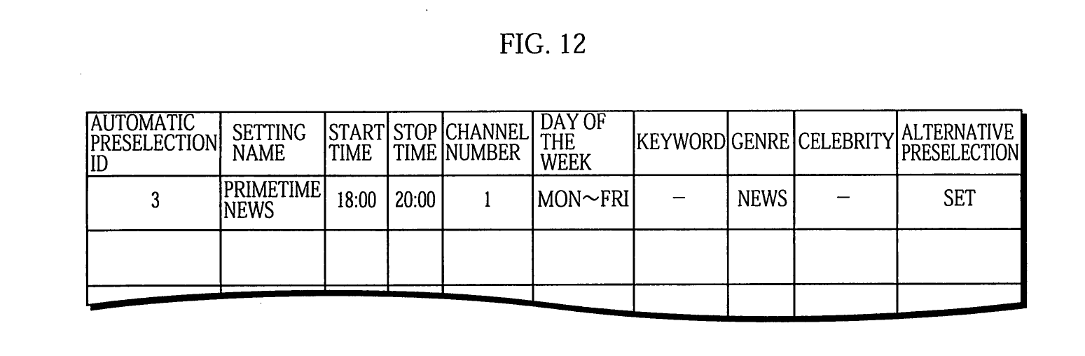

FIG. 12 shows an example of the automatic preselection table stored in the automatic preselection information storing unit 3 in the program preselecting apparatus of the second embodiment.

This automatic preselection table has entries for automatic preselection ID, setting name, start time, stop time, channel number, day of the week, keyword, genre, celebrity, and alternative preselection. All entries but the automatic preselection ID are set by the user.

The sole difference with the automatic preselection table in FIG. 3 lies in that the priority has been changed to the alternative preselection.

The alternative preselection is a flag which is set or cleared. When a program retrieved based on a set of preselection information whose alternative preselection is set is scheduled in a time slot overlapping with a program retrieved based on another set of preselection information, the former program is replaced with a program scheduled in a different time slot.

In the set of preselection information in the automatic preselection table shown in FIG. 12, a news aired on channel 1 from 18:00 to 20:00 is planned to record every day from Monday to Friday, where the alternative preselection is set.

The preselection managing unit 2 has the electronic program guide searching unit 4 search an electronic program guide for a program that satisfies each set of preselection information in the automatic preselection table, when a new set of preselection information is registered in the automatic preselection information storing unit 3, when the electronic program guide is updated, or at regular time intervals. If time slots of programs retrieved as a result overlap and one of the programs has been retrieved based on a set of preselection information whose alternative preselection is set, instead of preselecting the program the preselection managing unit 2 has the electronic program guide searching unit 4 search for an alternative program that satisfies the set of preselection information except for time, and stores information necessary for recording the alternative program into the preselected program table storing unit 6.

(Operation)

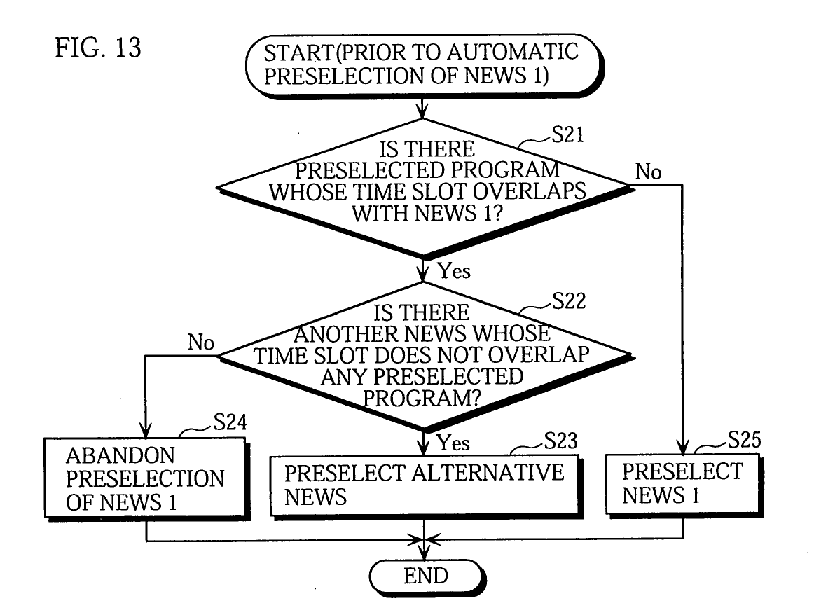

FIG. 13 is a flowchart showing a program preselection procedure of the preselection managing unit 2 in the program preselecting apparatus of the second embodiment. Assume from the electronic program guide the electronic program guide searching unit 4 has retrieved a program (News 1) that satisfies the set of preselection information in the automatic preselection table shown in FIG. 12. Here, the program preselecting apparatus is unable to record more than one program simultaneously.

The program preselection procedure of the preselection managing unit 2 in this case is as follows.

(1) Prior to preselection of News 1 retrieved based on the set of preselection information whose automatic preselection ID is “3”, judge whether the preselected program table contains a program whose time slot overlaps a time slot of News 1 (S21).

(2) If there is a preselected program (Program 3) whose time slot overlaps the time slot of News 1, relax the set of preselection information in regard to time and judge whether there is a program similar to News 1 in a different time slot (S22). More specifically, it is judged whether there is another news on channel 1 which is scheduled in a time slot not overlapping with any of Program 3 and other preselected programs.

(3) If a program (News 2) that satisfies the condition of step S22 is found, preselect News 2 as an alternative to News 1 to complete the procedure (S23).

(4) If there is no program that satisfies the condition of step S22, on the other hand, complete the procedure without preselecting any program (S24).

(5) If there is no preselected program whose time slot overlaps with News 1, preselect News 1 to complete the procedure (S25).

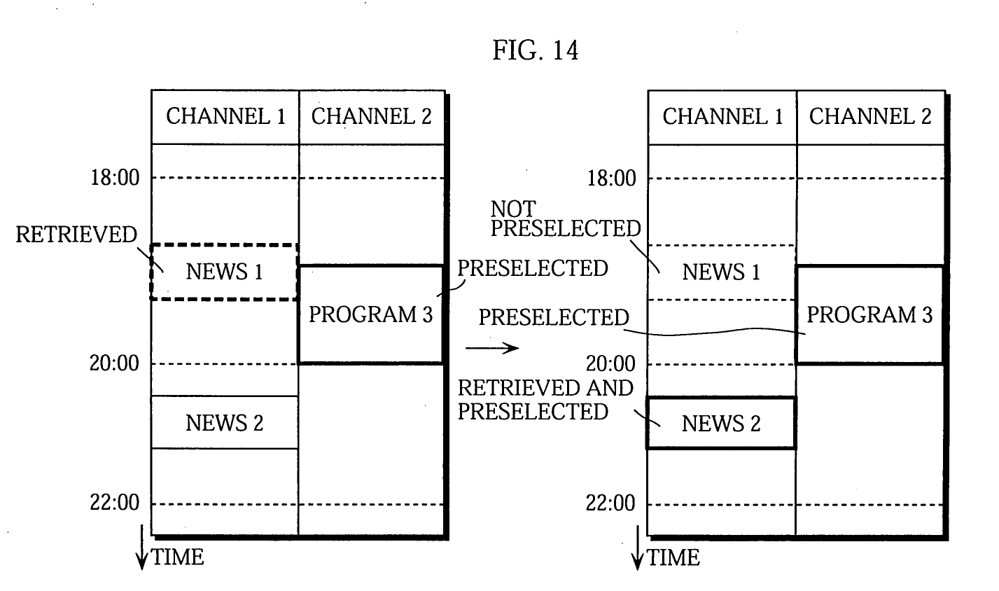

FIG. 14 is a diagrammatic sketch of the program preselection procedure shown in FIG. 13.

On the left side of the figure, News 1 has been retrieved while News 2 has not yet been searched for. Since the time slot of News 1 overlaps the time slot of Program 3 which has been preselected earlier, the alternative preselection of News 1 applies to this case.

On the right side of the figure, News 2 has been retrieved and preselected as an alternative to News 1.

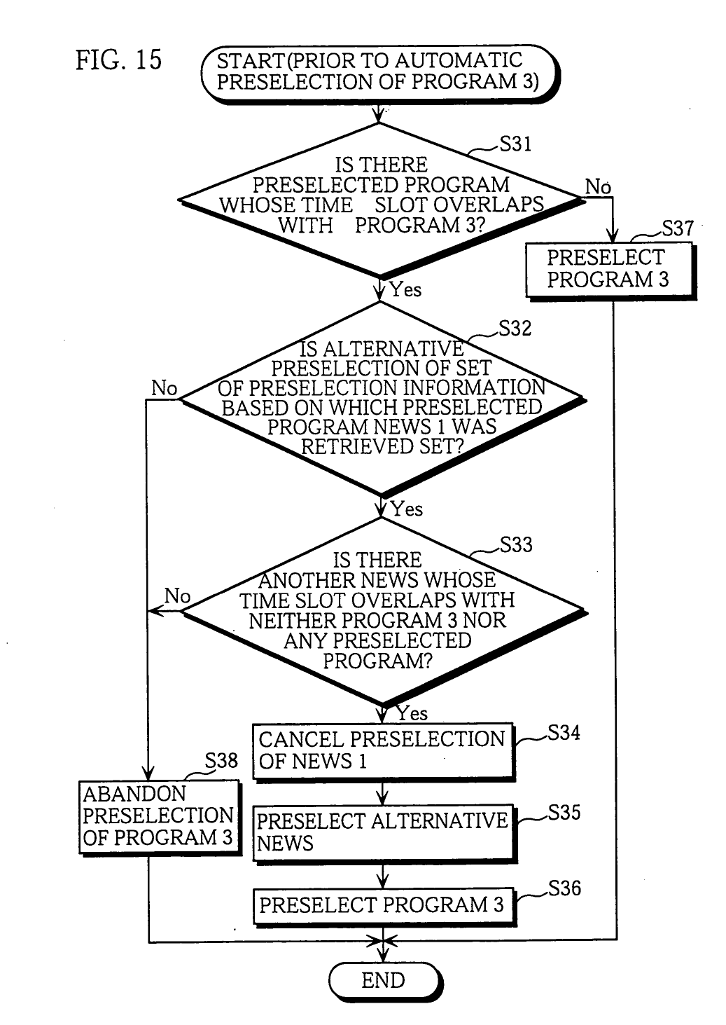

FIG. 15 is a flowchart showing another program preselection procedure of the preselection managing unit 2 in the program preselecting apparatus of the second embodiment. Assume after retrieving from the electronic program guide News 1 that satisfies the set of preselection information in the automatic preselection table shown in FIG. 12, the electronic program guide searching unit 4 has retrieved Program 3 that satisfies another set of preselection information (not shown in FIG. 12) in the automatic preselection table. Here, the program preselecting apparatus is unable to record more than one program at the same time.

The program preselection procedure of the preselection managing unit 2 in this case is as follows.

(1) Prior to preselection of Program 3, judge whether the preselected program table contains a program whose time slot overlaps a time slot of Program 3 (S31).

(2) If there is such a preselected program, check a set of preselection information based on which the preselected program was retrieved whether its alternative preselection is set (S32). In the present example, a time slot of News 1 overlaps with Program 3 and the alternative preselection of the set of preselection information corresponding to News 1 is set.

(3) If the alternative preselection is set, relax the set of preselection information in regard to time and judge whether there is a program similar to News 1 in a different time slot (S33). More specifically, it is judged whether there is another news on channel 1 that is scheduled in a time slot overlapping with neither Program 3 nor any preselected program.

(4) If there is a program (News 2) which satisfies the condition of step S33 is found, cancel the preselection of News 1 (S34).

(5) preselect News 2 as an alternative to News 1 (S35).

(6) Lastly preselect Program 3 to complete the procedure (S36).

(7) If there is no preselected program whose time slot overlaps with Program 3 in step S31, preselect Program 3 to complete the procedure (S37).

(8) If the alternative preselection of the set of preselection information is cleared in step S32 or if no program that satisfies the above condition is found in step S33, complete the procedure without preselecting Program 3 (S38).

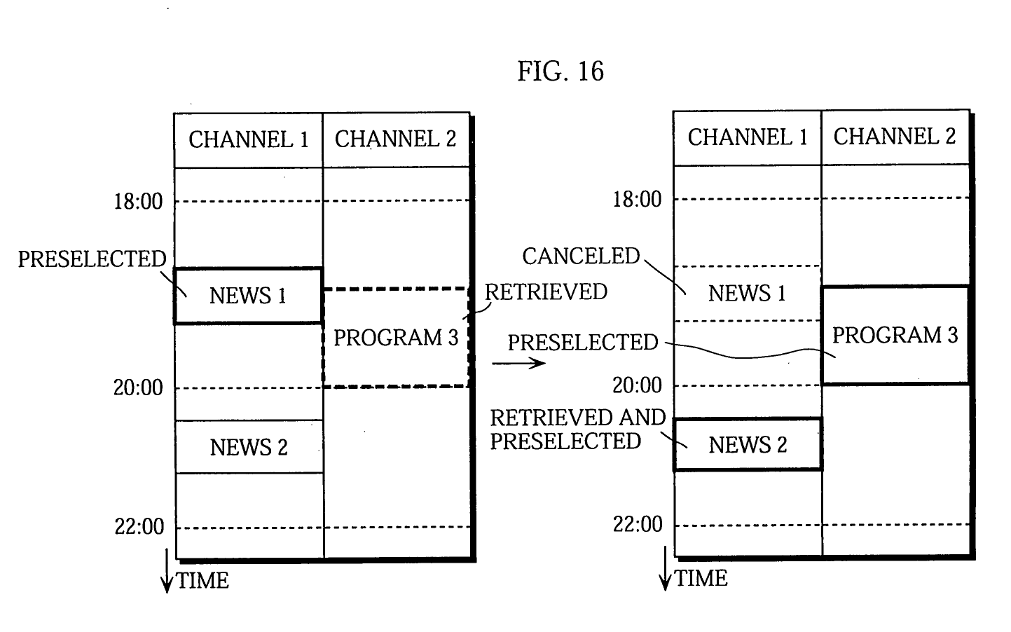

FIG. 16 is a diagrammatic sketch of the program preselection procedure shown in FIG. 15.

On the left side of the figure, Program 3 has been retrieved after preselection of News 1, at which point in time News 2 has not been searched for yet. Since the time slot of Program 3 overlaps the time slot of News 1, the alternative preselection of News 1 applies to this case.

On the right side of the figure, News 2 has been retrieved and preselected and further Program 3 has been preselected, while the preselection of News 1 has been canceled.

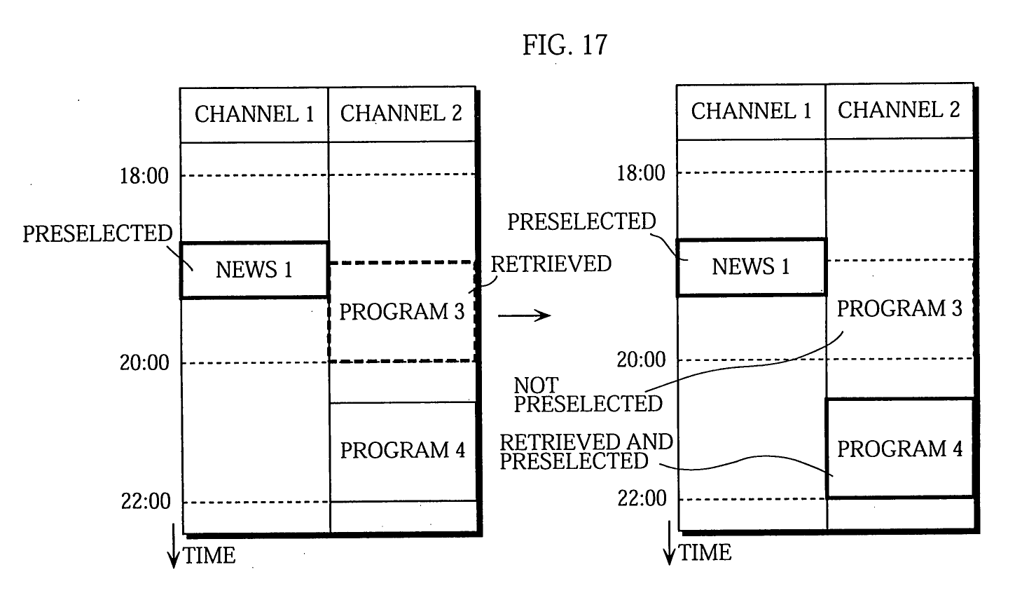

FIG. 17 is a diagrammatic sketch of the program preselection procedure shown in FIG. 15 where the alternative preselection of the set of preselection information based on which Program 3 has been searched for is set.

On the left side of the figure, Program 3 has been retrieved after preselection of News 1, at which point in time Program 4 has not been searched for yet. Since the time slot of Program 3 overlaps the time slot of News 1, the alternative preselection of Program 3 applies to this case.

On the right side of the figure, Program 4 has been retrieved and preselected as an alternative to Program 3.

As described above, when an overlap of time slots occurs between a program to be automatically preselected and an automatically preselected program, the alternative preselection is performed based on user-specified alternative preselection entries of two sets of preselection information corresponding to the two programs, thereby saving the user from having to decide which of the programs with overlapping time slots should be chosen.

While in the above embodiment a set of preselection information has been relaxed in regard to time, the set of preselection information may instead be relaxed in regard to channel number, genre, or the like.

### Third Embodiment

A program preselecting apparatus of the third embodiment of the present invention is different with the first embodiment in that its automatic preselection table includes a preselection guarantee entry. Suppose a time slot of a program retrieved based on a set of preselection information whose preselection guarantee is set overlaps with another retrieved program. If an alternative program that satisfies the set of preselection information exists in a time slot not overlapping with the other program, the alternative program is preselected as an alternative to the originally retrieved program. If the alternative program does not exist, on the other hand, the originally retrieved program takes precedence over the other program in automatic preselection.

(Configuration)

The configuration of the program preselecting apparatus of the third embodiment is mainly the same as the first embodiment, so that the following explanation focuses on the differences with the first embodiment.

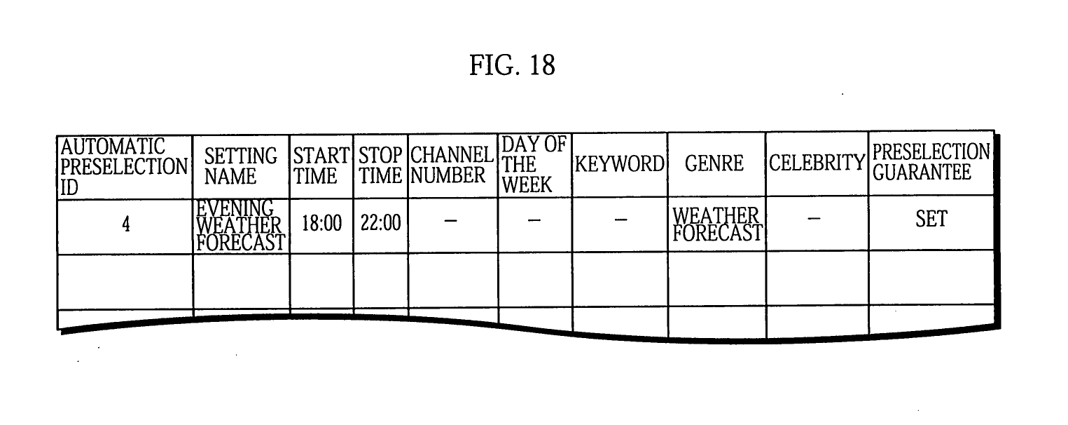

FIG. 18 shows an example of the automatic preselection table stored in the automatic preselection information storing unit 3 in the program preselecting apparatus of the third embodiment.

This automatic preselection table has entries for automatic preselection ID, setting name, start time, stop time, channel number, day of the week, keyword, genre, celebrity, and preselection guarantee. All entries but the automatic preselection ID are specified by the user.

The difference with the automatic preselection table shown in FIG. 3 is that the priority has been changed to the preselection guarantee.

The preselection guarantee is a flag that is set or cleared. When a time slot of a program retrieved based on a set of preselection information whose preselection guarantee is set overlaps a time slot of a program retrieved based on another set of preselection information, the former program takes precedence over the latter program in automatic preselection. However, if there is a program which satisfies the set of preselection information of the former program and which does not overlap with the latter program, that program is preselected as an alternative to the former program.

In the set of preselection information in the automatic preselection table shown in FIG. 18, a weather forecast aired from 18:00 to 22:00 is planned to record every day, where the preselection guarantee is set.

The preselection managing unit 2 has the electronic program guide searching unit 4 search an electronic program guide for a program that satisfies each set of preselection information in the automatic preselection table, when a new set of preselection information is registered in the automatic preselection information storing unit 3, when the electronic program guide is updated, or at regular time intervals. If a program retrieved based on a set of preselection information whose preselection guarantee is set has a time slot overlapping with another retrieved program, the former program takes precedence over the latter program in automatic preselection, so that the preselection managing unit 2 stores information necessary for recording the former program into the preselected program table storing unit 6. However, if there is an alternative program that satisfies the set of preselection information of the former program and that is scheduled in a time slot not overlapping with the latter program, the preselection managing unit 2 stores information necessary for recording the alternative program, instead of the former program, into the preselected program table storing unit 6.

(Operation)

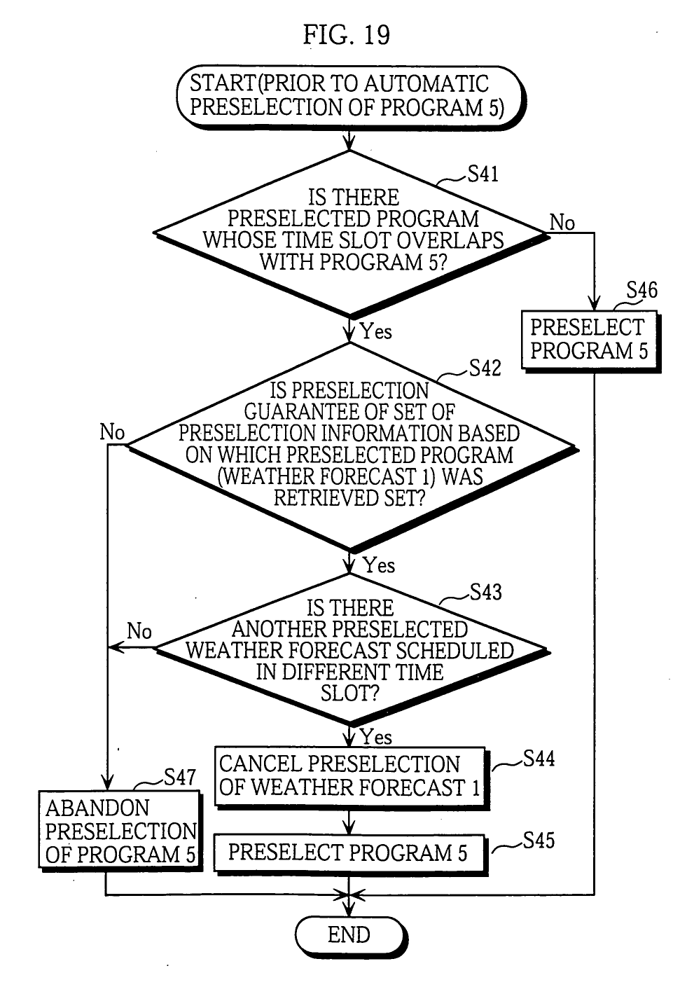

FIG. 19 is a flowchart showing the program preselection procedure of the preselection managing unit 2 in the program preselecting apparatus of the third embodiment. Suppose after two programs (Weather Forecast 1 and Weather Forecast 2) that satisfy the set of preselection information in the automatic preselection table shown in FIG. 18 were retrieved from the electronic program guide and preselected, the electronic program guide searching unit 4 has retrieved a program (Program 5) that satisfies another set of preselection information (not shown in FIG. 18) in the automatic preselection table. Here, the program preselecting apparatus cannot record more than one program at the same time.

This being so, the program preselection procedure of the preselection managing unit 2 is as follows.

(1) Prior to preselection of program 5, judge whether the preselected program table contains a program whose time slot overlaps a time slot of Program 5 (S41).

(2) If there is a preselected program (Weather Forecast 1) whose time slot overlaps the time slot of Program 5, check the set of preselection information based on which the preselected program was retrieved whether its preselection guarantee is set (S42). In the present example, the preselection guarantee of the set of preselection information corresponding to Weather Forecast 1 is set as illustrated in FIG. 18.

(3) If the preselection guarantee of the set of preselection information is set, judge whether there is a preselected program that satisfies the set of preselection information and that is scheduled in a different time slot (S43). More specifically, it is judged whether there is a preselected weather forecast during 18:00˜22:00 which overlaps with neither Program 5 nor other preselected programs.

(4) If there is a preselected program (Weather Forecast 2) that satisfies the condition of step S43, cancel the preselection of Weather Forecast 1 (S44).

(5) Preselect Program 5 to complete the procedure (S45).

(6) If there is no preselected program whose time slot overlaps with Program 5 in step S41, preselect Program 5 and complete the procedure (S46).

(7) If the preselection guarantee of the set of preselection information is cleared in step S42 or if there is no preselected program similar to Weather Forecast 1 in a time slot not overlapping with Program 5 in step S43, complete the procedure without preselecting Program 5 (S47).

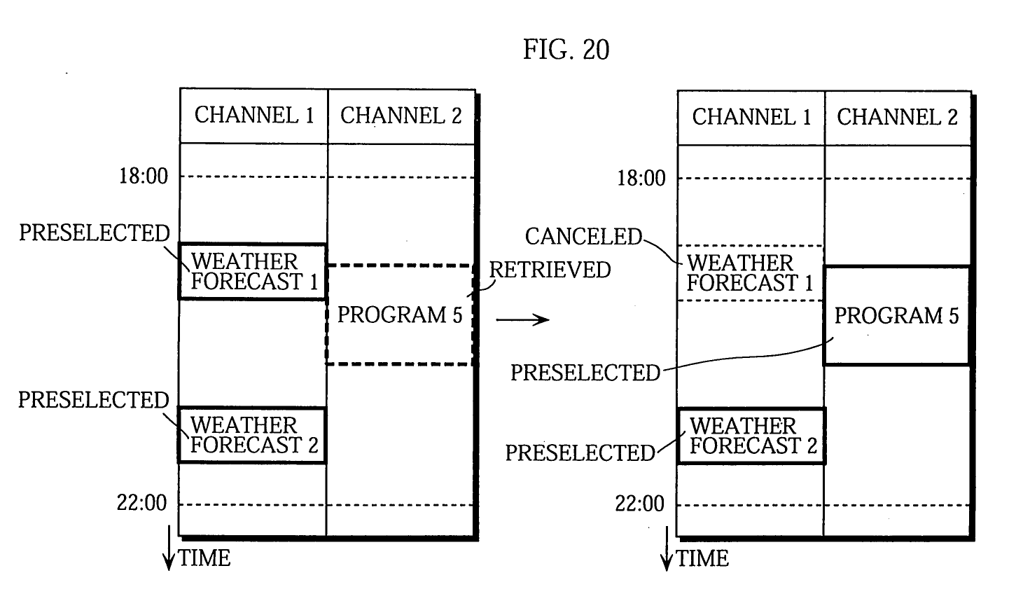

FIG. 20 is a diagrammatic sketch of the program preselection procedure shown in FIG. 19.

On the left side of the figure, Program 5 has been retrieved after preselection of Weather Forecast 1 and Weather Forecast 2 which were retrieved based on the same set of preselection information. As illustrated, the time slot of Program 5 overlaps the time slot of Weather Forecast 1.

On the right side of the figure, the preselection of Weather Forecast 1 has been canceled and Program 5 has been preselected.

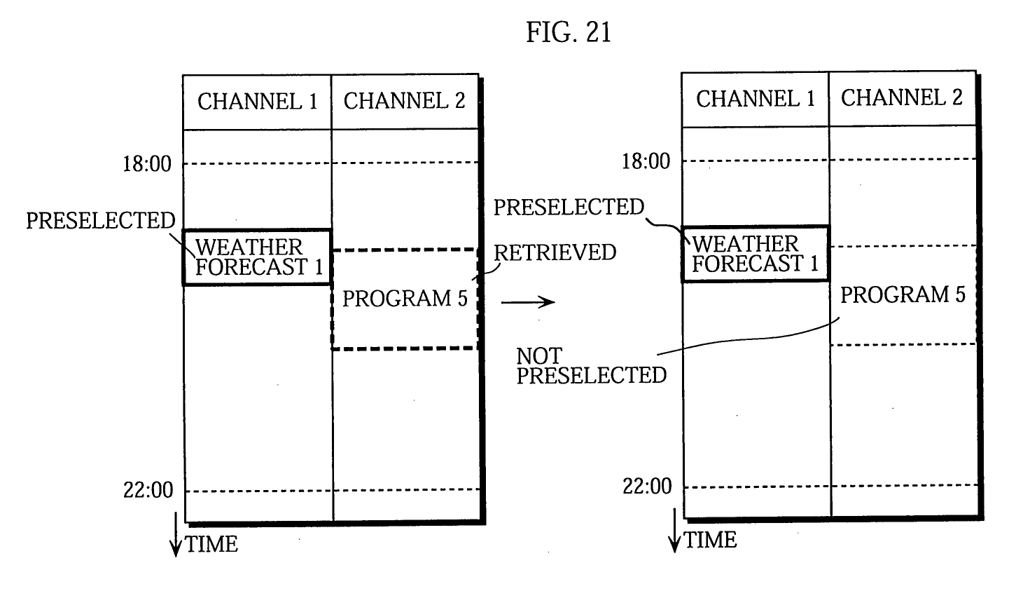

FIG. 21 is another diagrammatic sketch of the program preselection procedure shown in FIG. 19.

On the left side of the figure, Program 5 has been retrieved after preselection of Weather Forecast 1. As illustrated, the time slot of Program 5 overlaps the time slot of Weather Forecast 1.

On the right side of the figure, preselection of Program 5 has been abandoned.

As described above, when an overlap of time slots occurs between a program to be automatically preselected and an automatically preselected program, preselection of one of the programs is guaranteed based on user-specified preselection guarantee entries of sets of preselection information corresponding to the programs. Moreover, the user does not have to decide which of the programs with overlapping time slots should be recorded.

### Fourth Embodiment

A program preselecting apparatus of the fourth embodiment of the present invention automatically generates prioritized sets of preselection information same as those in the first embodiment based on a history of programs viewed or preselected for recording by the user in the past, to use the generated sets of preselection information for searches on an electronic program guide as in the first embodiment. In this embodiment and embodiments that follow, a set of preselection information is referred to as an automatic program preselection criterion.

(Configuration)

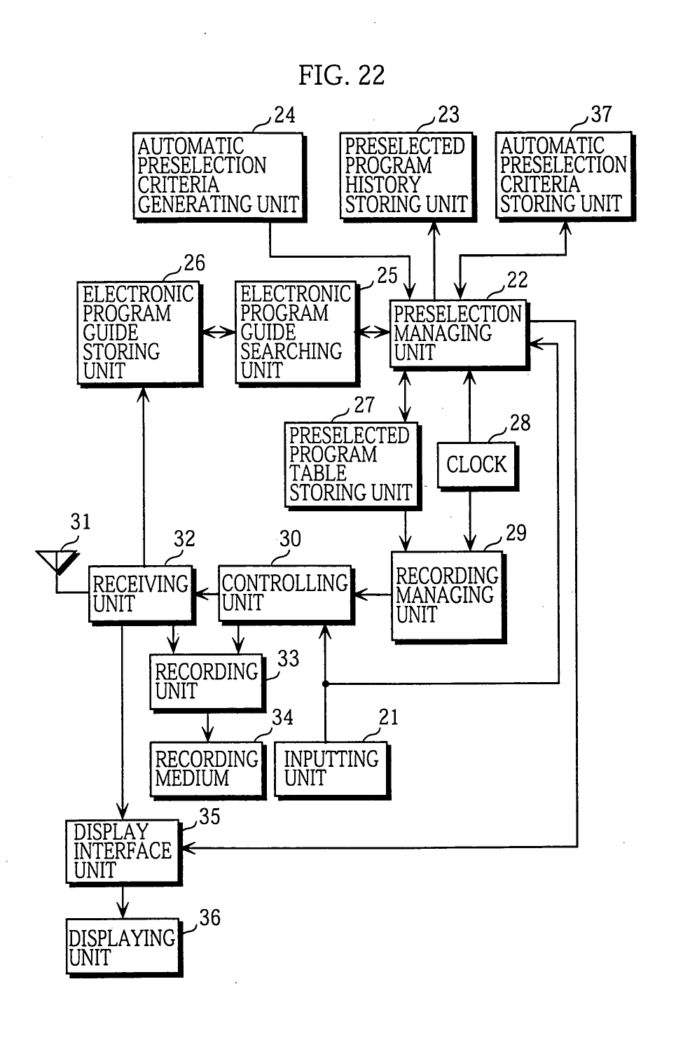

FIG. 22 shows the configuration of the program preselecting apparatus of the fourth embodiment of the present invention.

This program preselecting apparatus is roughly made up of an inputting unit 21, a preselection managing unit 22, a preselected program history storing unit 23, an automatic preselection criteria generating unit 24, an automatic preselection criteria storing unit 37, an electronic program guide searching unit 25, an electronic program guide storing unit 26, a preselected program table storing unit 27, a clock 28, a recording managing unit 29, a controlling unit 30, an antenna 31, a receiving unit 32, a recording unit 33, a recording medium 34, a display interface unit 35, and a displaying unit 36.

The inputting unit 21 is made up of switches of a remote control or front panel and receives user indications and user-specified automatic program preselection criteria.

The preselection managing unit 22 manages user-specified automatic program preselection criteria and automatic program preselection criteria automatically generated by the automatic preselection criteria generating unit 24. Through this preselection managing unit 22, the user-specified automatic program preselection criteria received by the inputting unit 21 and the automatic program preselection criteria generated by the automatic preselection criteria generating unit 24 are stored into the automatic preselection criteria storing unit 37.

The preselected program history storing unit 23 stores preselected program history information that shows a history of programs viewed or preselected for recording by the user in the past.

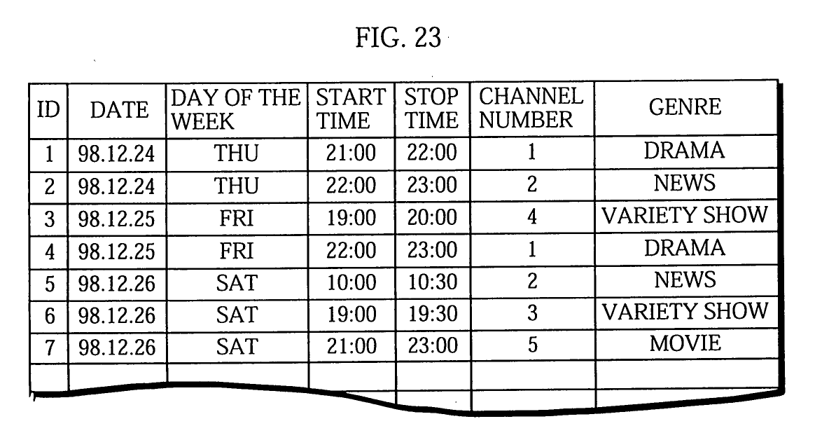

FIG. 23 shows an example of the preselected program history information stored in the preselected program history storing unit 23.

This preselected program history information is made up of entries for program ID, date, day of the week, start time, stop time, channel number, and genre.

The automatic preselection criteria generating unit 24 generates automatic program preselection criteria based on the preselected program history information stored in the preselected program history storing unit 23.

The automatic preselection criteria storing unit 37 receives automatic program preselection criteria from the preselection managing unit 22 and stores them in the form of an automatic preselection table.

The electronic program guide searching unit 25 searches an electronic program guide for a program that satisfies each automatic program preselection criterion in the automatic preselection table stored in the automatic preselection criteria storing unit 37.

The electronic program guide storing unit 26 stores electronic program guide data received via the receiving unit 32.

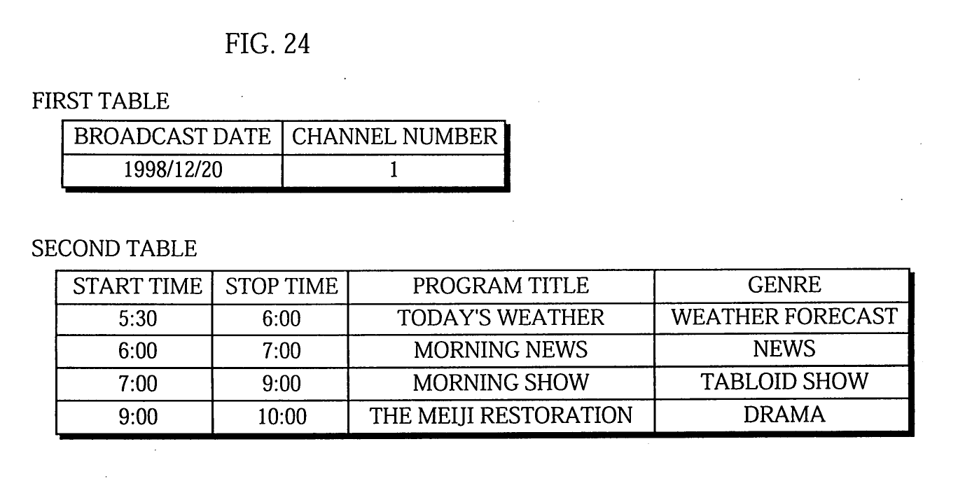

FIG. 24 shows an example of the electronic program guide data stored in the electronic program guide storing unit 26.

This electronic program guide data is made up of a first table showing a broadcast date and a channel number and a second table showing information on each program to be broadcasted. The information on each program includes a start time, a stop time, a program title, and a genre. Electronic program guide data for each of a plurality of channels is transmitted from a respective broadcast station in every few days (e.g. every 8 days) and is stored in the electronic program guide storing unit 26.

The preselected program table storing unit 27 stores a preselected program table which shows information, such as a time slot and a channel number, of each preselected program.

The clock 28 outputs current date and time information.

The recording managing unit 29 manages recording of each preselected program according to the preselected program table stored in the preselected program table storing unit 27 and the date and time information outputted from the clock 28.

The controlling unit 30 controls the recording unit 33 and a receive channel of the receiving unit 32.

The antenna 31 receives a carrier wave.

The receiving unit 32 receives via the antenna 31 the carrier wave that carries TV program data and electronic program guide data superimposed thereon, and outputs the TV program data and the electronic program guide data respectively to the recording unit 33 and the electronic program guide storing unit 26.

The recording unit 33 records TV program data into the recording medium 34.

The recording medium 34 is a medium such as a hard disk for recording TV program data.

The display interface unit 35 converts GUI display information for an electronic program guide or the like into signals suitable for display by the displaying unit 36.

The displaying unit 36 displays TV programs and GUI displays.

The preselection managing unit 22 has the electronic program guide searching unit 25 search the electronic program guide for a program that satisfies each automatic program preselection criterion in the automatic preselection table, when a new automatic program preselection criterion is registered in the automatic preselection criteria storing unit 37, when the electronic program guide is updated, or at regular time intervals. If time slots of programs found as a result of the search overlap, the preselection managing unit 22 chooses one of the programs based on priorities given to automatic program preselection criteria based on which the programs have been retrieved, and stores information necessary for recording the chosen program into the preselected program table storing unit 27.

At this time, the preselection managing unit 22 writes “automatic” in the preselected program table as the preselection mode of the chosen program, and copies a priority of an automatic program preselection criterion corresponding to the chosen program in the automatic preselection table to the preselected program table as the priority for the chosen program.

Also, a program can be manually preselected by the user via the inputting unit 21. In such a case, the preselection managing unit 22 writes “user-designated” in the preselected program table as the preselection mode of the program, while leaving the priority entry of the program in the preselected program table blank.

(Operation)

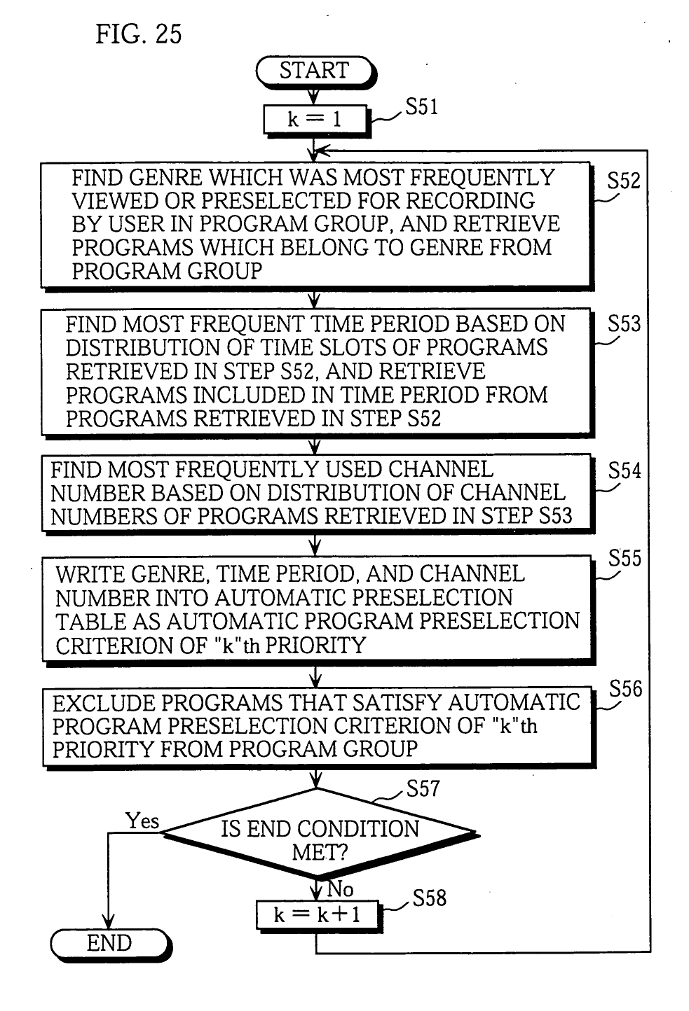

FIG. 25 is a flowchart showing the procedure of generating automatic program preselection criteria by the automatic preselection criteria generating unit 24.

This procedure is performed in the following manner.

(1) Assign an initial value “1” to algebraic value k that represents a priority (S51).

(2) Find a genre which was most frequently viewed or preselected for recording by the user (i.e. a genre with highest selection rate) in a program group, and retrieve programs of the genre from the program group (S52). Here, the program group denotes a group of all programs included in the preselected program history information in the preselected program history storing unit 23.

(3) Find the most frequent time period based on a distribution of time slots of the programs retrieved in step S52, and retrieve programs included in the time period from the programs retrieved in step S52 (S53).

(4) Find the most frequently used channel number based on a distribution of channel numbers of the programs retrieved in step S53 (S54).

(5) Write the genre, time period, and channel number obtained in steps S52-S54 together into the automatic preselection table as an automatic program preselection criterion of the “k”th priority (S55).

(6) Exclude programs that satisfy the automatic program preselection criterion of the “k”th priority from the program group (S56).

(7) Check whether an end condition is met (S57). If the end condition is met, end the procedure. The end condition referred to here is, for example, for the number of automatic program preselection criteria to reach a predetermined number, or for a proportion of programs that satisfy any of the automatic program preselection criteria among all programs in the preselected program history information to reach a predetermined proportion.

(8) If the end condition is unmet, increment k by 1 (S58) and return to step S52 to generate an automatic program preselection criterion of the next lower priority.

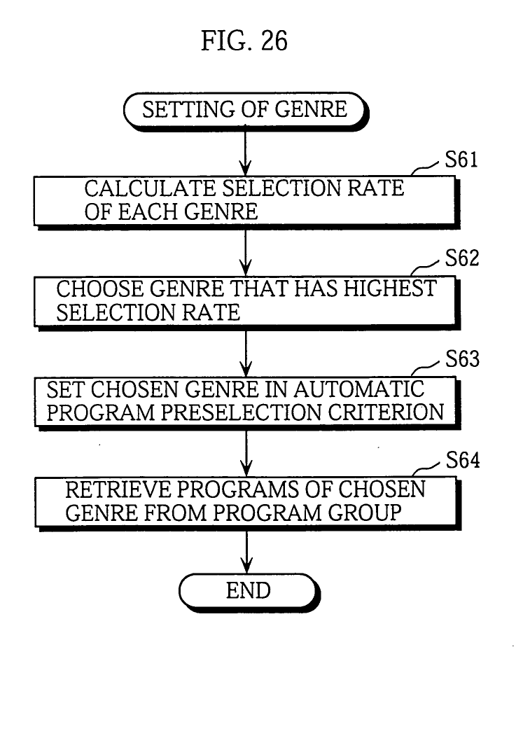

FIG. 26 is a flowchart showing the detailed process of step S52 in FIG. 25.

The detection of the genre most frequently viewed or preselected for recording by the user and the retrieval of programs belonging to the genre from the preselected program history information stored in the preselected program history storing unit 23 are performed as follows.

(1) Calculate a selection rate of each genre for all programs in the preselected program history information (S61).

To be more specific, a selection rate of a certain selection criterion such as a genre is calculated by dividing the number of programs in the preselected program history information of a past specific period of time which satisfy the selection criterion by the number of programs in an electronic program guide of the past specific period of time which satisfy the selection criterion. The selection rate calculated as such expresses the rate of the user viewing or preselecting programs that satisfy the selection criterion in that specific period of time. For instance, a selection rate of each genre in the past two weeks is computed in the following way.

To compute the selection rate of each genre, first the preselection managing unit 22 sorts programs included in daily electronic program guides of the past two weeks according to their genres, and outputs the number of programs of each genre to the automatic preselection criteria generating unit 24.

The automatic preselection criteria generating unit 24 receives the number of programs (first number) of each genre broadcasted in the past two weeks. The automatic preselection criteria generating unit 24 then sorts programs included in the preselected program history information according to their genres, counts the number of programs (second number) of each genre viewed or preselected for recording by the user in the past two weeks, and divides the second number by the first number to obtain the selection rate of each genre.

(2) After the selection rate of each genre is computed, choose a genre that has the highest selection rate (S62).

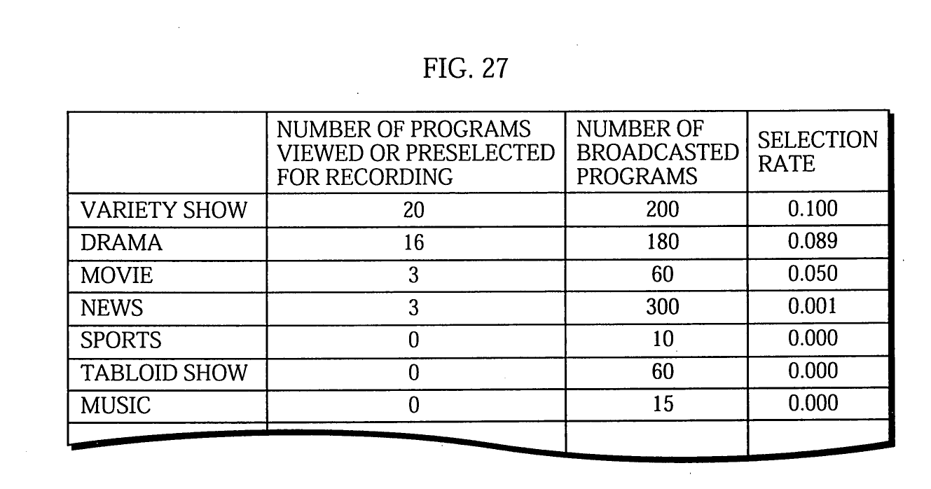

FIG. 27 shows selection rates corresponding to genres. Here, the genre “variety show” has the highest selection rate.

(3) Set the chosen genre (“variety show”) in the automatic program preselection criterion of the first priority (S63).

(4) Retrieve programs belonging to the chosen genre from the preselected program history information (S64).

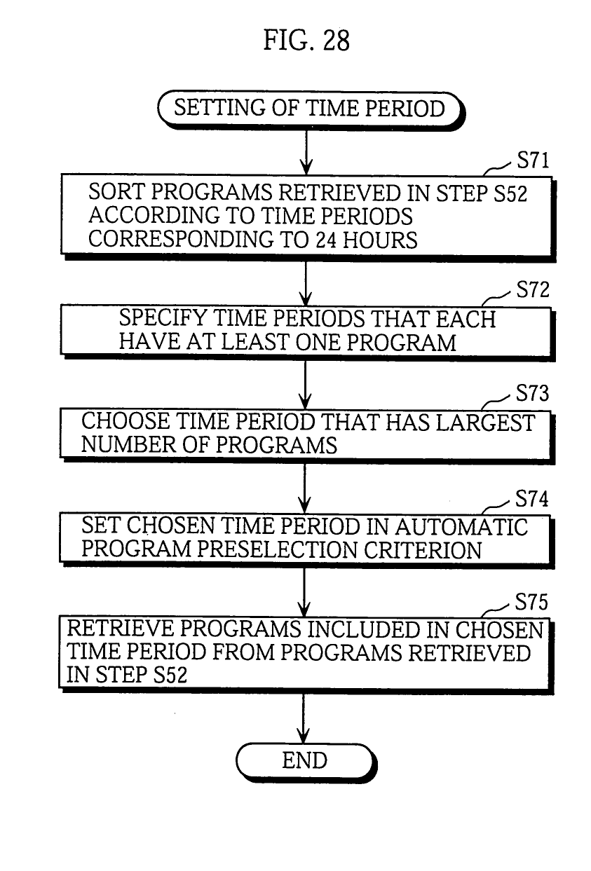

FIG. 28 is a flowchart showing the detailed process of step S53 in FIG. 25.

The detection of the most frequent time period based on a distribution of time slots of the programs retrieved in step S52 and the retrieval of programs included in the time period from the programs retrieved in step S52 are performed as follows.

(1) Having set individual hours of a day as time periods, sort the programs retrieved in step S52 according to the time periods during which they are present (S71). For example, a program aired from 10:30 to 11:30 is sorted into both the 10:00˜11:00 time period and the 11:00˜12:00 time period.

(2) Specify each time period having at least one program (S72). Here, two or more successive time periods which each have at least one program are regarded as one time period.

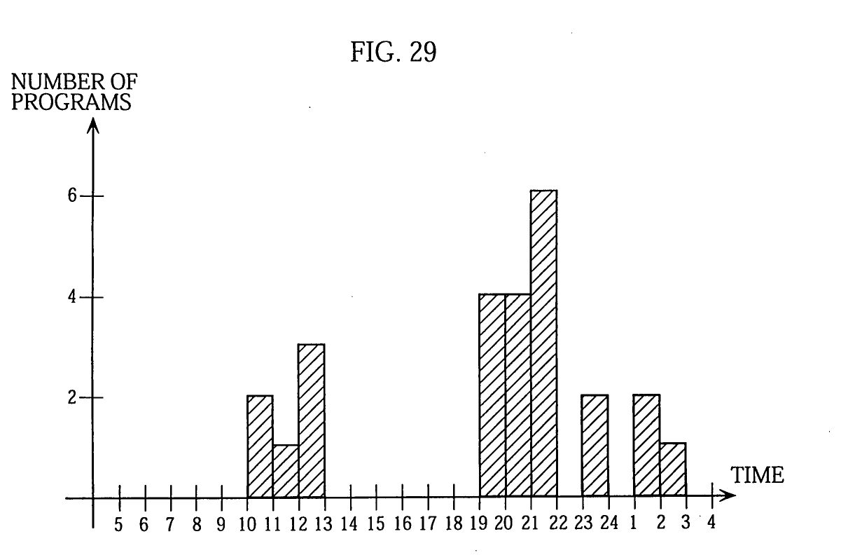

FIG. 29 shows the number of variety show programs sorted by time. Since two or more successive time periods which each have at least one program are regarded as one time period, four time periods that are 10:00˜13:00, 19:00˜22:00, 23:00˜24:00, and 1:00˜3:00 are established in this figure.

(3) Count the number of programs in each of the time periods established in step S72. Here, a program whose time slot is 10:30˜11:30 is counted as one program in the 10:00˜13:00 time period. Then choose a time period that has the largest number of programs (S73). In FIG. 29, the 19:00˜22:00 time period has the largest number of programs.

(4) Set the chosen time period in the automatic program preselection criterion (S74).

(5) Retrieve programs that are included in the chosen time period from the programs retrieved in step S52 (S75). In the present example programs whose time slots are within 19:00˜22:00 are retrieved.

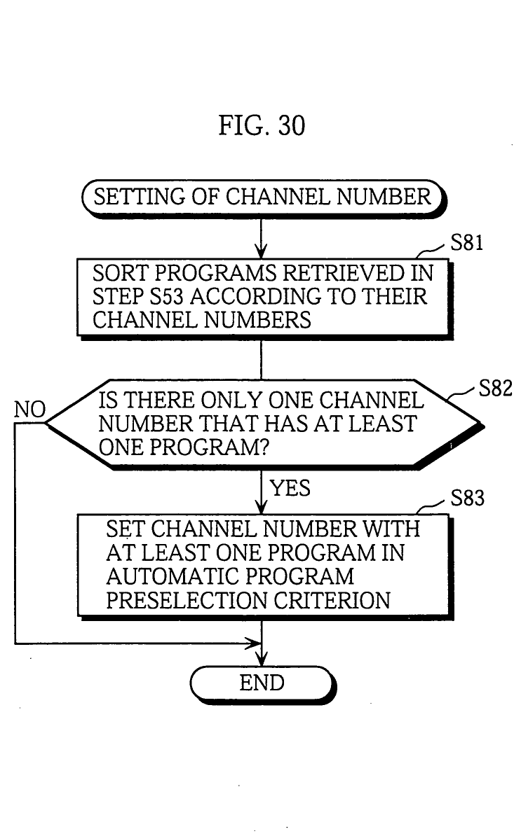

FIG. 30 is a flowchart showing the detailed process of step S54 in FIG. 25.

The detection of the most frequently used channel number based on a distribution of channel numbers of the programs retrieved in step S53 is performed as follows.

(1) Sort the programs retrieved in step S53 according to their channel numbers (S81).

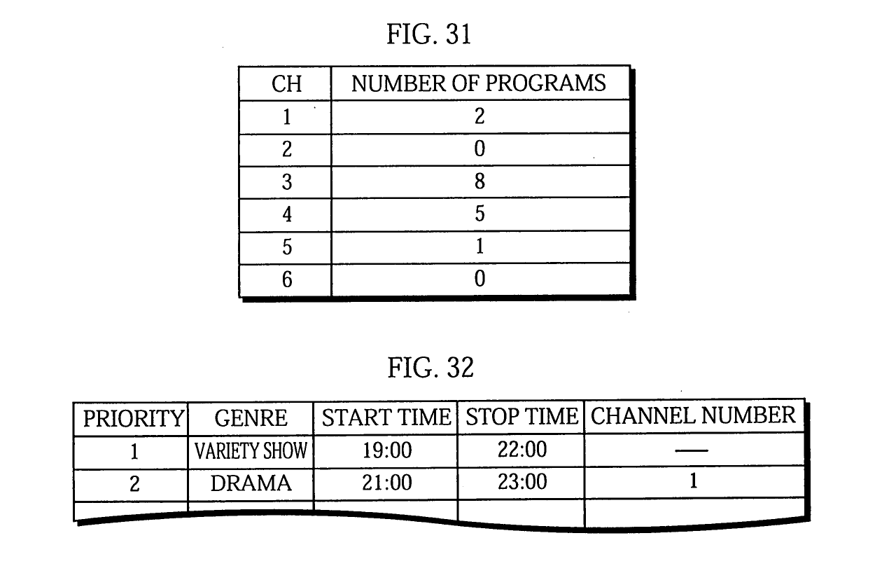

FIG. 31 shows an example of numbers of programs corresponding to channel numbers (S81).

(2) Check whether there is only one channel number that has at least one program (S82). If there are a plurality of channel numbers that each have at least one program, end the process without setting any channel number in the automatic program preselection criterion.

In FIG. 31 there are four channels 1, 3, 4, and 5 that each include at least one program, so that no channel number is set in the automatic program preselection criterion.

(3) If there is only one channel number that has at least one program, that channel number is set in the automatic program preselection criterion (S83).

FIG. 32 shows an example of automatic program preselection criteria generated by the automatic preselection criteria generating unit 24.

The automatic program preselection criterion of the first priority in the figure is the automatic program preselection criterion generated as a result of the above described processes.

Thus, automatic program preselection criteria are automatically generated based on a history of programs previously viewed or preselected for recording by the user, with it being possible to free the user from having to manually set automatic program preselection criteria. Also, since selection rates are considered to be consistent with user preferences, assigning higher priorities to automatic program preselection criteria with higher selection rates ensues generation of automatic program preselection criteria that reflect the user preferences.

Next, when time slots of programs retrieved through the use of the generated automatic program preselection criteria overlap, one of the programs is chosen in the following manner.

If the automatic program preselection criteria based on which the programs with the overlapping time slots have been retrieved have different priorities, a program corresponding to a preselection criterion of higher priority is chosen as in the first embodiment.

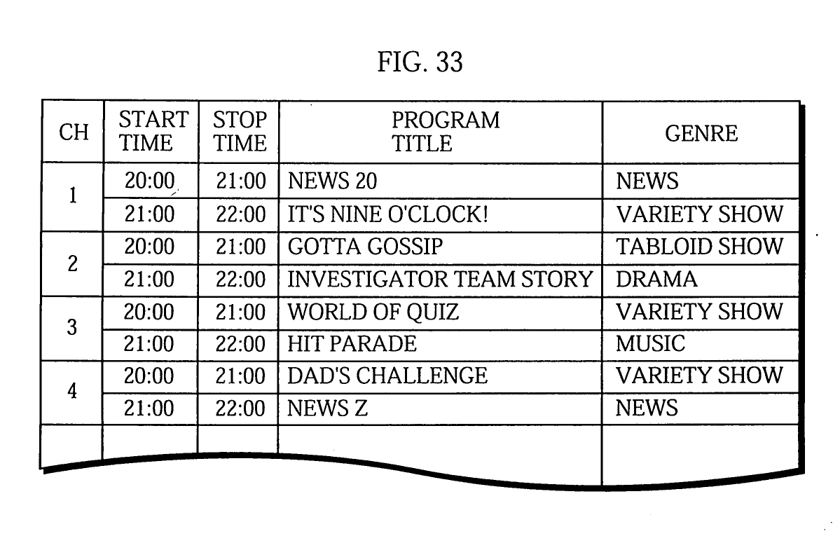

FIG. 33 shows an example of a part of electronic program guide data stored in the electronic program guide storing unit 26.

Suppose the electronic program guide searching unit 25 searches this electronic program guide data for programs that satisfy the automatic program preselection criteria shown in FIG. 32. Then the time slot of the program “It's Nine O'clock!” on channel 1 which satisfies the automatic program preselection criterion of the first priority overlaps the time slot of the program “Investigator Team Story” on channel 2 which satisfies the automatic program preselection criterion of the second priority, as they are both scheduled from 21:00 to 22:00. Since the two programs cannot be recorded simultaneously, it is necessary to choose one of the programs. Comparing the priorities of the automatic program preselection criteria corresponding to the two programs indicates the automatic program preselection criterion of the program “It's Nine O'clock!” has the higher priority than the automatic program preselection criterion of the program “Investigator Team Story”. Accordingly, “It's Nine O'clock!” is preselected.

Thus, based on the priorities given to the automatic program preselection criteria, it is possible to choose a program which is preferred by the user.

On the other hand, if automatic program preselection criteria based on which programs with overlapping time slots have been retrieved have the same priority, one of the programs is chosen according to priorities assigned to channel numbers.

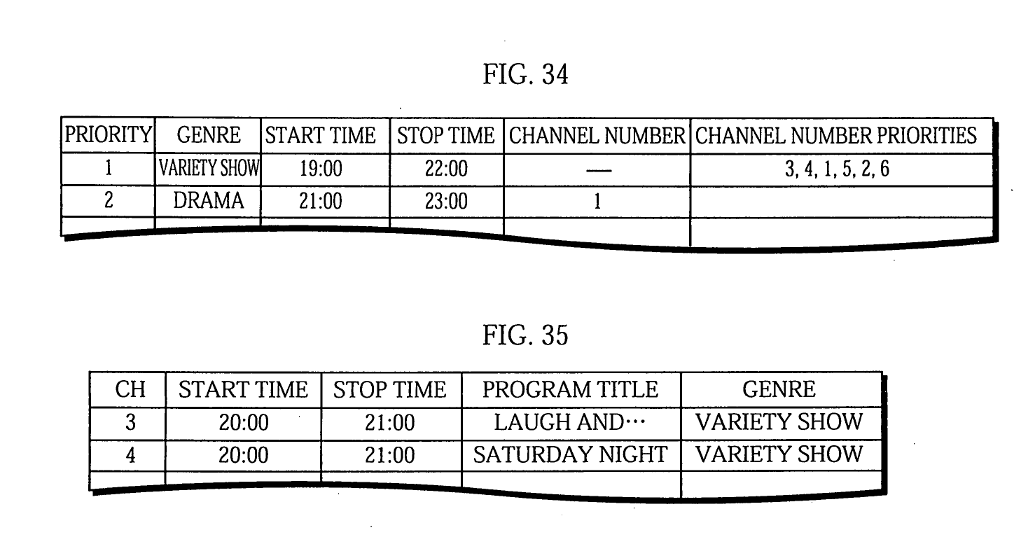

Which is to say, if there are a plurality of channel numbers that each include at least one program in step S83 in FIG. 30, the plurality of channel numbers are prioritized in such a manner that higher priorities are given to channel numbers having more programs, and the priorities of the plurality of channel numbers are added in the automatic program preselection criterion in the automatic preselection table. In the case of FIG. 31, for instance, channels 3, 4, 1, 5, 2, and 6 are given descending priorities (see FIG. 34). Here, if two or more channel numbers include the same number of programs, higher priorities are given to smaller channel numbers for expediency's sake.

FIG. 34 shows an automatic preselection table where the channel number priorities have been added to the automatic program preselection criterion of the first priority in FIG. 32.

Suppose the electronic program guide data in FIG. 33 is searched for programs using the automatic program preselection criteria shown in FIG. 34. Since the program “World of Quiz” on channel 3 and the program “Dad's Challenge” on channel 4 that satisfy the automatic program preselection criterion of the first priority have the same time slot 20:00˜21:00 and so one of the programs needs to be chosen. When this happens, the program “World of Quiz” is chosen since channel 3 takes precedence over channel 4 according to the channel number priorities in the automatic program preselection criterion of the first priority in FIG. 34.

Assigning priorities to channel numbers in such a way ensures there will be no failure to choose a program.

Note here that channel number priorities may be set separately for days of the week.

FIG. 35 shows an example of a part of electronic program guide data for Saturday.

Assume the channel number priorities set in the automatic program preselection criterion of the first priority in FIG. 34 are for use in weekday, while channel number priorities for use in weekend are channels 4, 3, 1, 2, 5, and 6.

When the electronic program guide data in FIG. 35 is searched for programs using the automatic program preselection criteria, the program “Laugh and . . . ” on channel 3 and the program “Saturday Night” on channel 4 that satisfy the automatic program preselection criterion of the first priority have the same time slot 20:00˜21:00 and so cannot be recorded at the same time. In such a case, the program “Saturday Night” on channel 4 is chosen over the program “Laugh and . . . ” on channel 3 according to the channel number priorities set for weekend.

Though the channel numbers have been prioritized separately for weekday and weekend in the above example, the channel numbers may be prioritized in other ways. For example, prioritizing the channel numbers separately for different days of the week ensues automatic preselection that further reflects the user preferences.

Though the programs retrieved in step S53 have been sorted according to their channel numbers in the above example, alternatively all programs included in the preselected program history information in the preselected program history storing unit 23 may be sorted according to their channel numbers, so that descending priorities are assigned to channel numbers in descending order of numbers of programs. The channel number priorities set in such a way are not unique to a particular automatic program preselection criterion but is shared in the entire automatic preselection table. Also, only programs manually selected by the user may be sorted according to their channel numbers.

The following is an explanation of the procedure of automatically adjusting the amount of programs to be recorded depending on how much recording time remains in the recording medium 34.

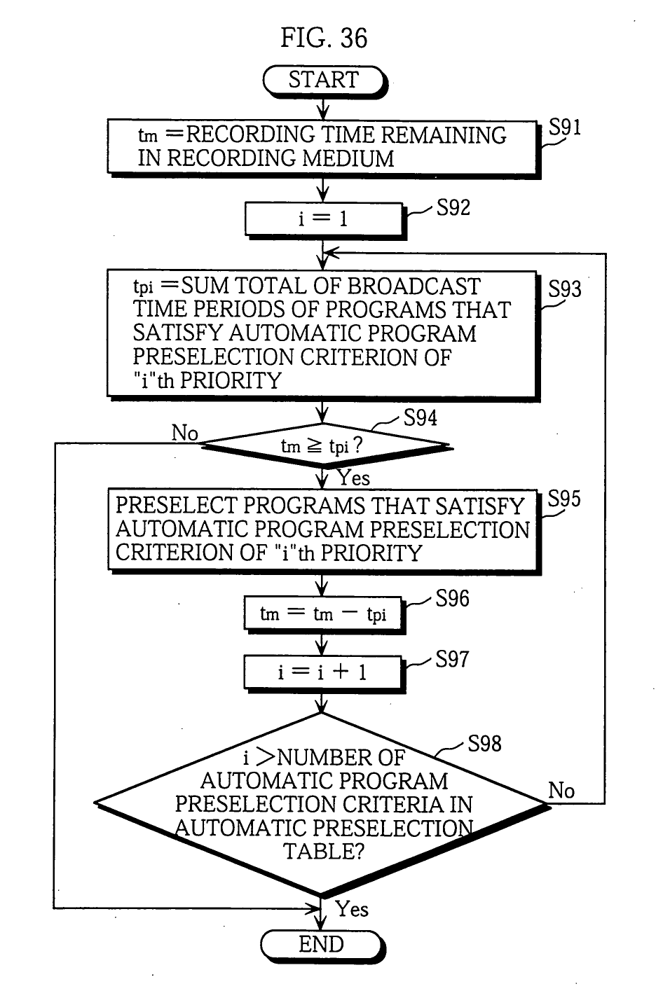

FIG. 36 is a flowchart showing the procedure of automatically adjusting the amount of programs to be recorded depending on the remaining recording time of the recording medium 34.

(1) Detect how much recording time (tm) remains in the recording medium 34 (S91).

(2) Assign an initial value “1” to algebraic value i that represents a priority (S92).

(3) Calculate the sum total (tpi) of broadcast time periods of all programs in the electronic program guide in the electronic program guide storing unit 26 that satisfy the automatic program preselection criterion of the “i”th priority (S93).

(4) Judge whether tm≧tpi (S94). If tm<tpi (i.e. the recording medium 34 does not have enough space for recording the programs that satisfy the automatic program preselection criterion of the “i”th priority), end the procedure.

(5) If tm≧tpi, the programs that satisfy the automatic program preselection criterion of the “i”th priority are preselected for recording (S95).

(6) Renew tm by subtracting tpi from tm (S96).

(7) Increment i by 1 (S97).

(8) Judge whether i exceeds the number of automatic program preselection criteria in the automatic preselection table (S98). If i exceeds the number of automatic program preselection criteria, end the procedure. Otherwise, return to step S93 to repeat the same procedure for the automatic program preselection criterion of the next lower priority.

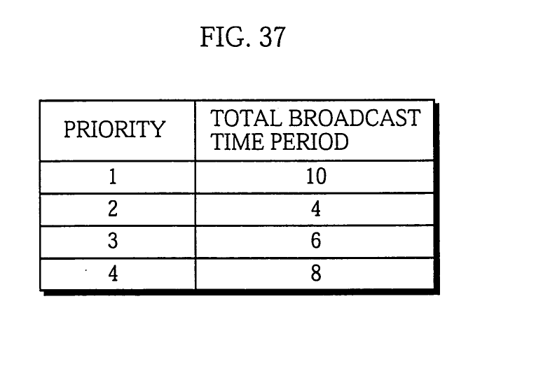

FIG. 37 shows the total broadcast time period of programs in a week ahead that satisfy an automatic program preselection criterion, for four automatic program preselection criteria of the first to fourth priorities.

If the remaining recording time of the recording medium 34 is 12 hours, only programs that satisfy the automatic program preselection criterion of the first priority in the figure are preselected for recording. If, on the other hand, the remaining recording time is 22 hours, all programs that satisfy any of the automatic program preselection criteria of the first to third priorities are preselected for recording.

Thus, the program preselecting apparatus of the present embodiment can automatically record programs in order of descending precedence according to the recording time remaining in the recording medium 34.

While an automatic program preselection criterion has been made up of three items that are a genre, a time period, and a channel number in the above embodiment, the contents and number of items are not limited to such. For example, items such as a celebrity, a keyword, and the like may instead or additionally be used.

Also, items of the automatic program preselection criterion may be hierarchically arranged so that the automatic program preselection criterion includes higher items and lower items. One example is integrating genres such as “baseball game”, “tennis match”, and “golf match” into the higher item “sports”, or integrating genres such as “drama” and “movie” into the higher item “story”. Further, channels may be classified according to ground wave broadcasting and satellite broadcasting in order to establish channel groups.

While automatic program preselection criteria have been generated based on a history of programs previously viewed or preselected for recording by the user in the above embodiment, automatic program preselection criteria may also be generated based on programs recorded in real time or reproduced by the user. Alternatively, the user may choose programs from an electronic program guide for the purpose of generating automatic program preselection criteria.

While two or more successive time periods have been regarded as one time period in generation of an automatic program preselection criterion in the above embodiment, two or more time periods may be regarded as one time period even if they are not successive. For instance, if two time periods have an interval no more than a hour, such time periods may be treated as one time period. In the case of FIG. 29, 19:00˜22:00, 23:00˜24:00, and 1:00˜3:00 are integrated as one time period.

While a genre with the highest selection rate has been chosen in generation of an automatic program preselection criterion in the above embodiment, a genre which has the largest number of programs may be chosen instead. Alternatively, the selection rate and the number of programs may be combined together as a factor in choosing a genre.

### Fifth Embodiment

While the program preselecting apparatus of the fourth embodiment has automatically retrieved and preselected a program for recording, a program preselecting apparatus of the fifth embodiment of the present invention automatically retrieves and preselects a program for viewing.

(Configuration)

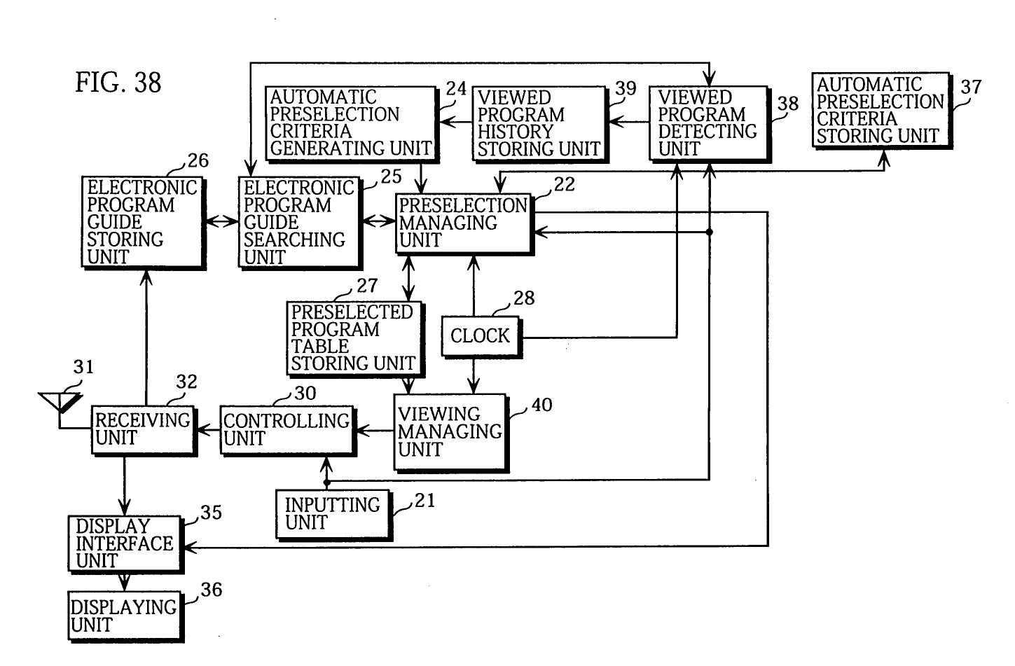

FIG. 38 shows the configuration of the program preselecting apparatus of the fifth embodiment.

This program preselecting apparatus includes the inputting unit 21, the preselection managing unit 22, a viewed program detecting unit 38, a viewed program history storing unit 39, the automatic preselection criteria generating unit 24, the automatic preselection criteria storing unit 37, the electronic program guide searching unit 25, the electronic program guide storing unit 26, the preselected program table storing unit 27, the clock 28, the controlling unit 30, the antenna 31, the receiving unit 32, a viewing managing unit 40, the display interface unit 35, and the displaying unit 36.

Note here that construction elements which are the same as those in the program preselecting apparatus of the fourth embodiment have been given the same reference names and numerals and their explanation has been omitted.

The viewed program detecting unit 38 detects programs viewed by the user.

The viewed program history storing unit 39 stores information of the programs detected by the viewed program detecting unit 38 as viewed program history information.

The viewing managing unit 40 outputs a channel number to the receiving unit 32 based on a preselected program table in the preselected program table storing unit 27.

(Operation)

The program preselecting apparatus of the fifth embodiment automatically preselects a program for viewing in the following way.

Whenever the user views a program, the viewed program detecting unit 38 searches an electronic program guide in the electronic program guide storing unit 26 for information on the viewed program based on a channel number inputted by the user via the inputting unit 21 and date and time information outputted from the clock 28, and stores the information into the viewed program history information in the viewed program history storing unit 39.

The automatic preselection criteria generating unit 24 generates automatic program preselection criteria based on the viewed program history information, and stores the generated automatic program preselection criteria into the automatic preselection criteria storing unit 37 as in the fourth embodiment.

The viewing managing unit 40 outputs a channel number to be received to the controlling unit 30 in accordance with the preselected program table in the preselected program table storing unit 27, as in the fourth embodiment.

Lastly, the controlling unit 30 has the receive channel of the receiving unit 32 switched to a channel of the channel number sent from the viewing managing unit 40.

Thus, the program preselecting apparatus of the present embodiment automatically selects a program and switches to a channel number of the program in consideration of user preferences, so that the user will not miss a program he or she likes.

### Sixth Embodiment

While the program preselecting apparatus of the fourth embodiment has automatically retrieved and preselected a program for recording and the program preselecting apparatus of the fifth embodiment has automatically retrieved and preselected a program for viewing, a program preselecting apparatus of the sixth embodiment of the present invention does not automatically preselect a program to view or record but provides the user with information for program preselection and preselects a program to view or record according to an instruction made by the user in response to the provided information.

(Configuration)

The configuration of the program preselecting apparatus of the sixth embodiment is similar to the program preselecting apparatus of the fourth embodiment or the fifth embodiment, so that the following explanation focuses on construction elements whose functions are different with the fourth embodiment and the fifth embodiment.

The preselection managing unit 22 manages automatic program preselection criteria specified by the user and automatic program preselection criteria automatically generated by the automatic preselection criteria generating unit 24. Through this preselection managing unit 22, the user-specified automatic program preselection criteria received by the inputting unit 21 and the automatic program preselection criteria generated by the automatic preselection criteria generating unit 24 are stored into the automatic preselection criteria storing unit 37.

The preselection managing unit 22 also has the electronic program guide searching unit 25 search an electronic program guide for a program that satisfies each automatic program preselection criterion in the automatic preselection criteria storing unit 37, has the displaying unit 36 display information on programs found as a result of the search in order of decreasing precedence, and stores information necessary for recording one of the programs chosen by the user via the inputting unit 21, into the preselected program table storing unit 27.

(Operation)

The operation of the program preselecting apparatus of the sixth embodiment is explained below, with the focus being given to the differences with the fourth and fifth embodiments.

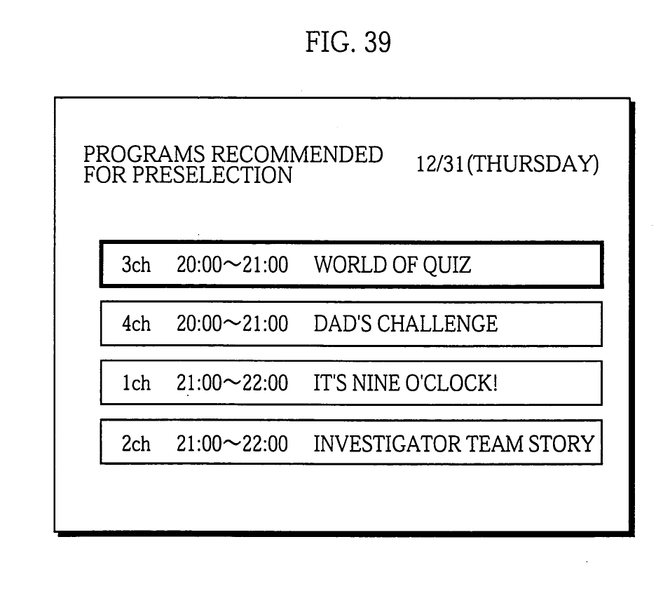

FIG. 39 shows an example of a menu display that shows programs recommended for preselection.

These programs have been retrieved according to the automatic program preselection criteria generated by the automatic preselection criteria generating unit 24 and are displayed in the form of menu on the displaying unit 36 under control of the preselection managing unit 22.

On this menu display the user moves a cursor and chooses one of the programs to view or record through the inputting unit 21.

Then the preselection managing unit 22 stores information of the chosen program into the preselected program table storing unit 27.

Thus, the program preselecting apparatus of the present embodiment displays information about programs retrieved according to user preferences, so that the user can efficiently choose one of the programs to view or record through the display.

### Seventh Embodiment

A program recording apparatus of the seventh embodiment of the present invention assigns a genre-specific retention period to a program to be recorded and automatically deletes the program whose retention period has passed.

(Configuration)

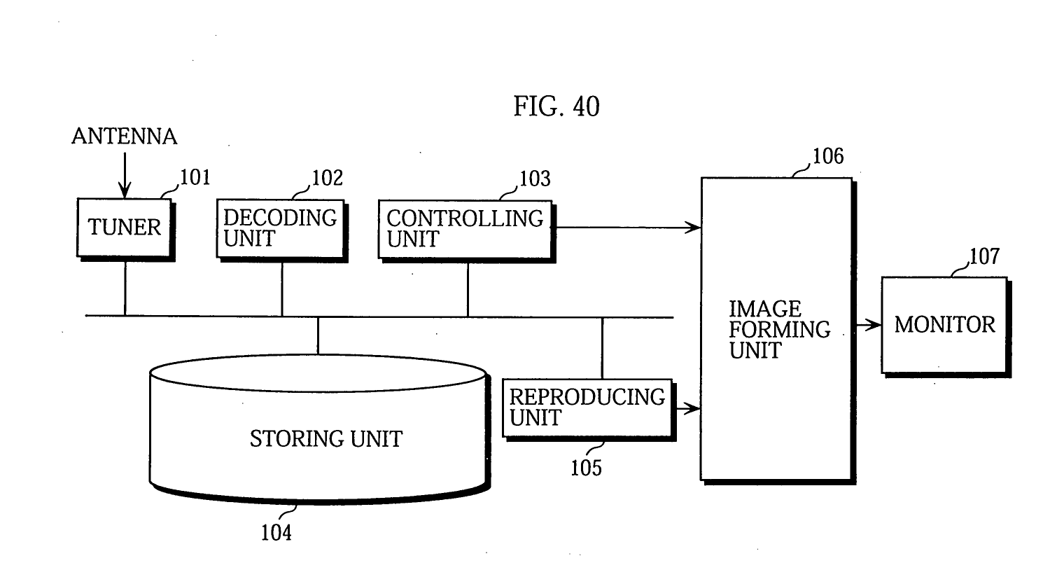

FIG. 40 shows the configuration of the program recording apparatus of the seventh embodiment.

This program recording apparatus includes a tuner 101, a decoding unit 102, a controlling unit 103, a storing unit 104, a reproducing unit 105, an image forming unit 106, and a monitor 107.

The tuner 101 receives a broadcast wave which carries program data and additional information superimposed thereon, and sends it to the decoding unit 102.

The decoding unit 102 decodes and demultiplexes the broadcast wave into the program data and the additional information such as EPG (electronic program guide) data, under control of the controlling unit 103.

The controlling unit 103 controls each component of the program recording apparatus according to user indications.

The storing unit 104 stores program data, program information, EPG data, user information, and so on in respective storing areas therein.

The user information referred to here is information used for determining parameters for retrieving programs which are to be automatically recorded, and is manually inputted by the user. After inputted by the user, the user information may be automatically modified.

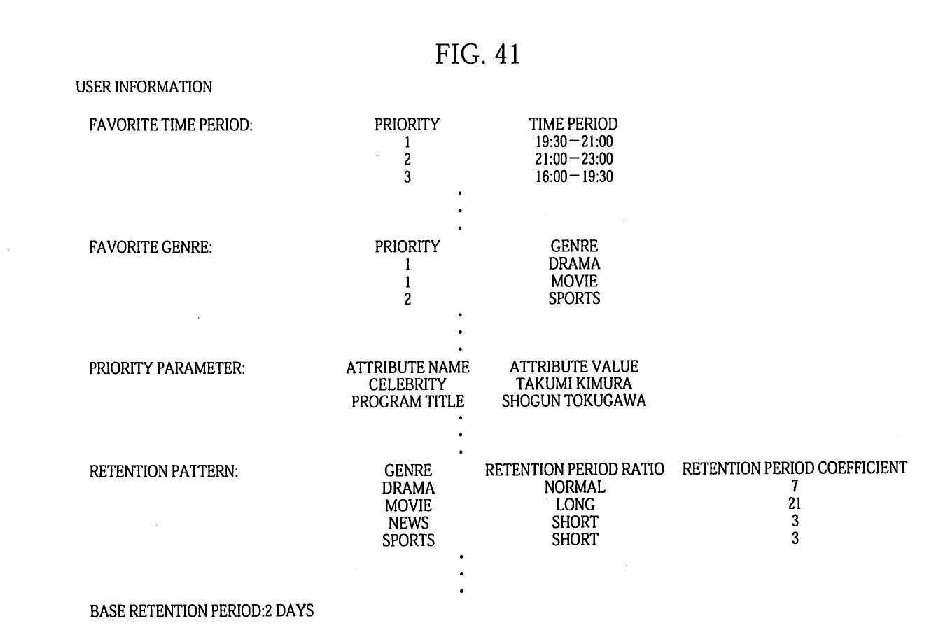

FIG. 41 is a diagrammatic sketch of the user information stored in the storing unit 104.

This user information is made up of five headings that are: “favorite time period” showing time periods preferred by the user for recording in order of precedence; “favorite genre” showing genres preferred by the user in order of precedence; “priority parameter” showing attribute values which should be specially given priority and attribute names of the respective attribute values; “retention pattern” showing, for different genres, retention period types such as “long”, “short”, and “normal” and retention period coefficients relative to a base retention period; and “base retention period” showing the predetermined base retention period. Here, a retention period is a minimum period of time during which a recorded program cannot be deleted unless the user explicitly indicates otherwise. In other words, a recorded program is securely retained in the storing unit 104 during its retention period, while once the retention period has passed the program may be automatically deleted. Here, the retention period can be extended to avoid the program from being deleted, if the user wants to retain the program longer. Items that make up the user information are hereinafter called parameters, among which parameters of “favorite time period”, “favorite genre”, and “priority parameter” are used as search parameters.

The reproducing unit 105 reproduces a program.

The image forming unit 106 superimposes the reproduced program on a GUI display generated by the controlling unit 103 to form the composite image.

The monitor 107 displays the image outputted from the image forming unit 106.

To record programs which are aired on separate channels at the same time, the tuner 101 is made up of a plurality of tuners which receive a respective plurality of channels in the case where two or more channel numbers are indicated. Similarly, the decoding unit 102 is made up of a plurality of decoders corresponding to the plurality of tuners. In this embodiment the tuner 101 and the decoding unit 102 are respectively equipped with two tuners and two decoders.

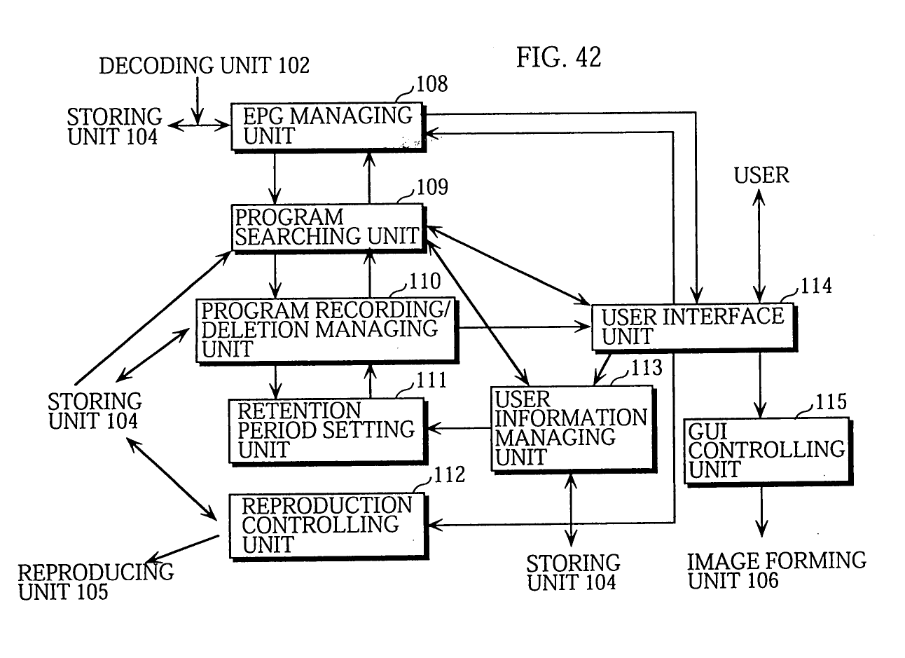

FIG. 42 shows the detailed construction of the controlling unit 103.

This controlling unit 103 is provided with an EPG managing unit 108, a program searching unit 109, a program recording/deletion managing unit 110, a retention period setting unit 111, a reproduction controlling unit 112, a user information managing unit 113, a user interface unit 114, and a GUI controlling unit 115.

Each time the decoding unit 102 acquires new EPG data, the EPG managing unit 108 replaces EPG data existing in the EPG data storing area in the storing unit 104 with the new EPG data. Also, the EPG managing unit 108 has a function of searching the EPG data stored in the storing unit 104 for programs according to broadcast time, channel number, genre, and/or celebrity. Therefore, when a search inquiry is sent from the program searching unit 109 or the user interface unit 114, the EPG managing unit 108 responds by sending a list of programs found based on the search inquiry.

The program searching unit 109 reads the user information in the storing unit 104 via the user information managing unit 113, and inquires of the program recording/deletion managing unit 110 about available automatic recording space in the program data storing area in the storing unit 104. On being notified of the available recording space, the program searching unit 109 modifies search criteria which are made up of at least one search parameter so that the total amount of record candidate programs found in the EPG data using the search criteria matches a proper level with respect to the available recording space. Once the search criteria have been modified, they remain unchanged until the program recording/deletion managing unit 110 or the user interface unit 114 instructs otherwise. On being indicated by the program recording/deletion managing unit 110 to search for record candidate programs, the program searching unit 109 has the EPG managing unit 108 search the EPG data for record candidate programs based on the modified search criteria and passes a list of the retrieved record candidate programs to the program recording/deletion managing unit 110. The program searching unit 109 also notifies the modified search criteria to the user.

The program recording/deletion managing unit 110 controls preselection of a program for recording, recording of the preselected program, and deletion of the recorded program and additional information thereof. The preselection is either manually performed by the user via the user interface unit 114 or automatically performed.

At the start of recording of the preselected program, the program recording/deletion managing unit 110 triggers the tuner 101 and the decoding unit 102 to receive data of the preselected program, has the retention period setting unit 111 set a retention period for the program, calculates a delete-protect date by adding the retention period to the recording date, and stores the program data and the delete-protect date into the storing unit 104.

Also, when the available recording space in the storing unit 104 is insufficient, the program recording/deletion managing unit 110 deletes data of one or more programs whose delete-protect dates have been reached, to increase the available recording space.

The retention period setting unit 111 sets a retention period of a program by multiplying the base retention period by a retention period coefficient corresponding to the program.

The reproduction controlling unit 112 reads from the program data storing area in the storing unit 104 data of a program indicated by the user, and passes the program data to the reproducing unit 105 so that the program is reproduced.

The user information managing unit 113 manages reference and rewriting of the user information. Whenever the user information is rewritten, the user information managing unit 113 notifies the rewriting to the program searching unit 109.

The user interface unit 114 receives a user operation, passes instructions to respective components in the program recording apparatus according to the user operation, and sends the content of a GUI display to the GUI controlling unit 115 so that the GUI display is displayed. For example, when the user wants to preselect a program for recording, the user interface unit 114 prompts the EPG managing unit 108 to display an electronic program guide shown by the EPG data in the storing unit 104. When the user chooses the program on the display, the user interface unit 114 instructs the program recording/deletion managing unit 110 to preselect the chosen program for recording. When the user wants to reproduce the recorded program, the user interface unit 114 inquires of the program recording/deletion managing unit 110 about a list of programs recorded in the storing unit 104, and has the GUI controlling unit 115 display the recorded program list.

The user interface unit 114 also rewrites the user information via the user information managing unit 113.

The GUI controlling unit 115 controls GUI displays.

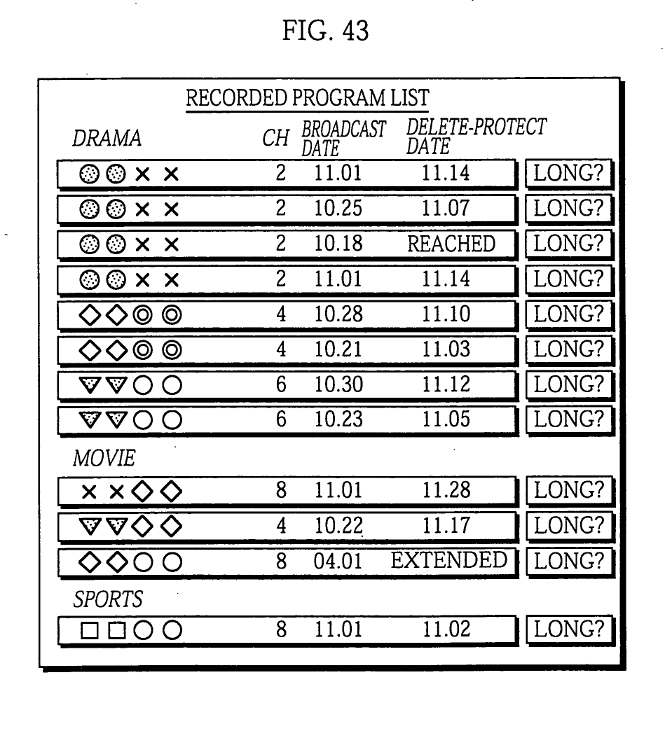

FIG. 43 shows an example of a GUI display that shows a recorded program list.

This recorded program list presents a title, channel number, broadcast date, and delete-protect date of each recorded program. As noted above, a delete-protect date is a date on when a retention period passes from a broadcast date. In the figure, retention periods of 14 days, 28 days, and 2 days have been given respectively to drama, movie, and sports.

Displaying delete-protect dates in such a way enables the user to understand until when each program is held in the storing unit 104. If the user wishes to prevent any of the displayed programs from being deleted after its delete-protect date, the user can extend the delete-protect date by pressing the “long?” button corresponding to the program.

(Operation)

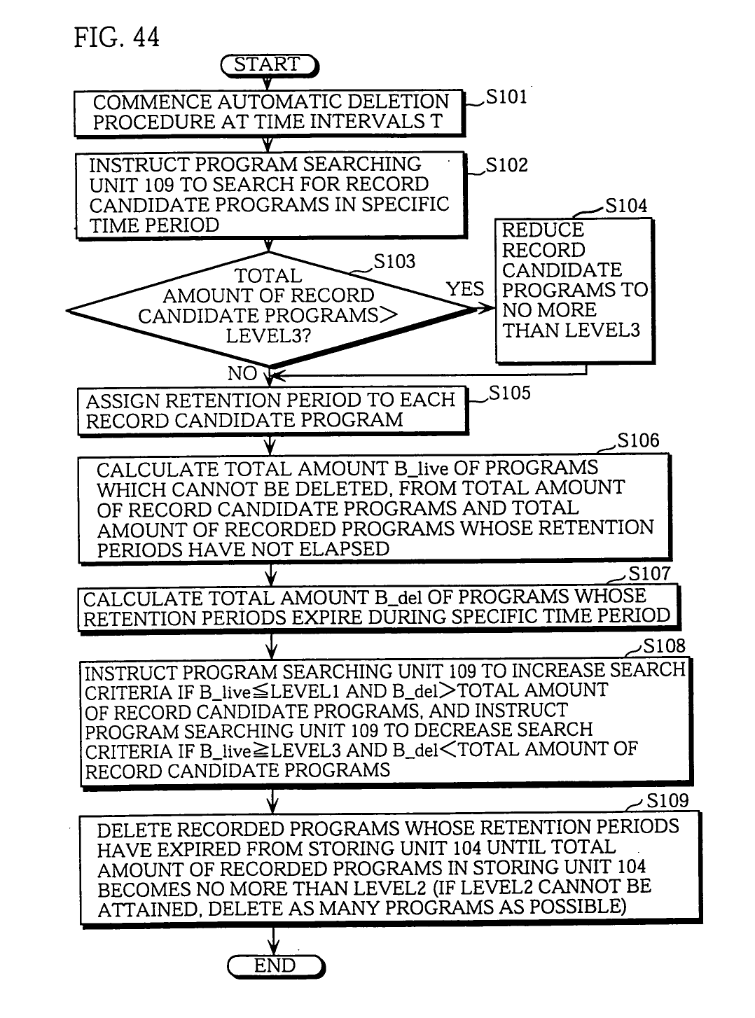

FIG. 44 is a flowchart showing the automatic deletion procedure of the program recording/deletion managing unit 110 during automatic recording.

The program recording/deletion managing unit 110 is activated at established time intervals T to perform automatic recording and automatic deletion. T is set to a day in the present example.

The automatic deletion procedure in automatic recording is performed as follows.

(1) Commence the automatic deletion procedure at established time intervals T (S101).

(2) Instruct the program searching unit 109 to search the EPG data in the storing unit 104 for record candidate programs in a specific time period (S102). Since most programs are broadcasted in a weekly basis, the specific time period is set to a week in the present example.

(3) Calculate the total amount of record candidate programs and judges whether the total amount exceeds a predetermined upper limit LEVEL3 (S103). LEVEL3 is set, for instance, at around 90% of the total capacity of the program data recording area in the storing unit 104.

(4) If the total amount of record candidate programs exceeds LEVEL3, reduce the number of record candidate programs until the total amount of record candidate programs becomes no more than LEVEL3 (S104). Though reducing the number of record candidate programs is not limited to a particular method, in this embodiment record candidate programs with later time slots are first to be excluded, while record candidate programs retrieved based on priority parameters are last to be excluded.

(5) Assign a retention period to each record candidate program (S105).

A retention period of a record candidate program is determined in the following fashion. First the program searching unit 109 notifies the user information managing unit 113 of a genre of the program. Then the user information managing unit 113 reads the base retention period and a retention period coefficient corresponding to the genre from the user information stored in the storing unit 104 and passes them to the retention period setting unit 111. Lastly the retention period setting unit 111 multiplies the base retention period by the retention period coefficient to determine the retention period.

(6) Add the total amount of record candidate programs to the total amount of recorded programs in the storing unit 104 whose retention periods have not passed, thereby obtaining the total amount B_live of programs that cannot be deleted (S106).

(7) Calculate the total amount B_del of recorded programs whose retention periods elapse during the specific time period (i.e. recorded programs whose deletion will be allowed during the specific time period) (S107).

(8) If B_live is no more than a predetermined lower limit LEVEL1 and the total amount of record candidate programs is less than B_del, instruct the program searching unit 109 to increase the number of search criteria, thereby increasing the number of record candidate programs.

If, on the other hand, B_live is no less than the upper limit LEVEL3 and the total amount of record candidate programs is more than B_del, instruct the program searching unit 109 to decrease the number of search criteria, thereby decreasing the number of record candidate programs (S108).

(9) Delete recorded programs whose retention periods have expired from the storing unit 104 in order of earlier delete-protect dates, until the total amount of programs recorded in the storing unit 104 becomes no more than a target amount LEVEL2 (S109). Here, if the target amount cannot be attained even after deleting every program whose retention period has expired, as many programs as possible are deleted from the storing unit 104.

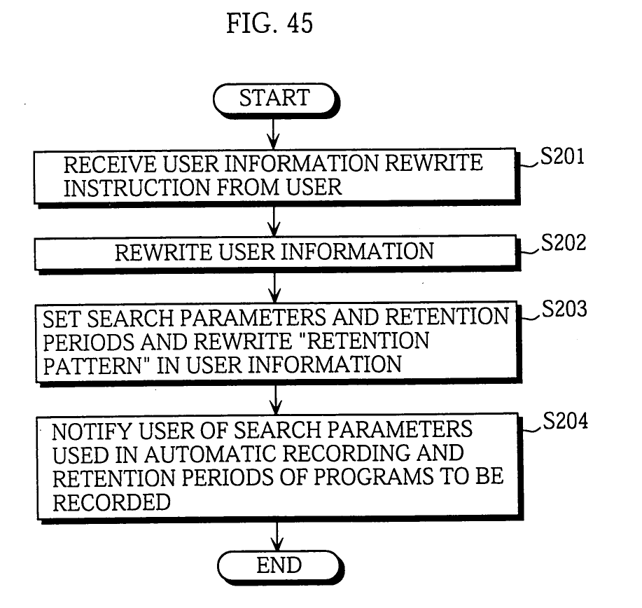

FIG. 45 is a flowchart showing the procedure of rewriting the user information.

The user information rewriting procedure is performed in the following manner.

(1) The user interface unit 114 receives an instruction to rewrite user information from the user (S201).

(2) The user information managing unit 113 rewrites the user information in the storing unit 104 and notifies the program searching unit 109 of the rewriting (S202).

(3) The program searching unit 109 sets search parameters and retention periods according to the new user information, notifies the user information managing unit 113 of the retention periods so that the contents of “retention pattern” in the user information are renewed, and passes the retention periods and search parameters to the user interface unit 114 (S203).

(4) The user interface unit 114 notifies the user of the search parameters to be used in automatic recording and the retention periods to be assigned to programs which will be recorded (S204).

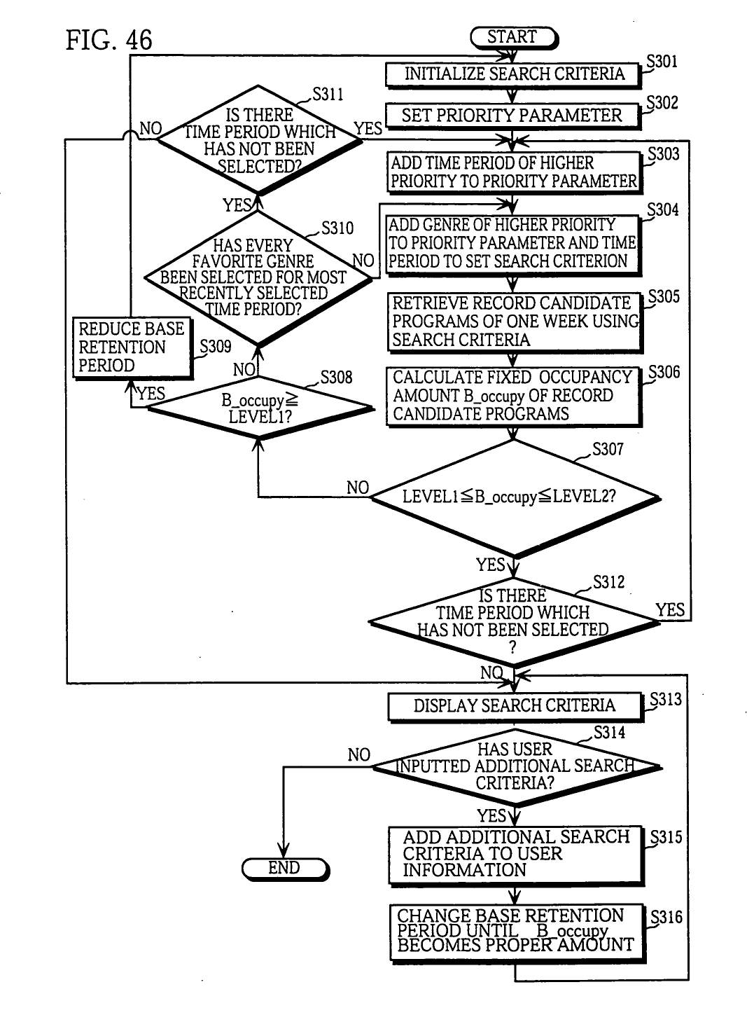

FIG. 46 is a flowchart showing the procedure of setting search criteria by the program searching unit 109.

This search criteria setting procedure is performed as follows.

(1) Initialize existing search criteria (S301).

(2) Retrieve a priority parameter from “priority parameter” in the user information (S302).

(3) Select a time period of higher priority among time periods which have not been selected, from “favorite time period” in the user information, and add the time period to the priority parameter (S303).

(4) Select a genre of higher priority from “favorite genre” in the user information, and add the genre to the priority parameter and time period to set a search criterion (S304). For example, if a priority parameter “Takumi Kimura”, a time period “19:00˜20:00”, and a genre “drama” are selected respectively in steps S302, S303 and S304, a search criterion “Takumi Kimura drama during 19:00˜20:00” is obtained.

(5) Search a weekly electronic program guide for record candidate programs using search criteria obtained so far (S305).

(6) Calculate a retention period of each record candidate program by multiplying the base retention period by a retention period coefficient of a genre of the program shown in “retention pattern” in the user information, and estimate a fixed occupancy amount B_occupy of the record candidate programs according to the following equation, on the assumption that the record candidate programs will be continued in a weekly basis (S306).

$$B\_occupy = {\sum }_{k}^{} \frac{k \times Pk}{1 w}$$

where k denotes a retention period, Pk denotes a total amount of record candidate programs whose retention periods are k, and 1w denotes time corresponding to a week.

Suppose the total amount of record candidate programs whose retention periods are one week (1w) is 3 GB (gigabyte), the total amount of record candidate programs whose retention periods are two weeks (2w) is 1 GB, and the total amount of record candidate programs whose retention periods are three weeks (3w) is 5 GB. Then (3 GB×1w+1 GB×2w+5 GB×3w)/1w=20 GB, so that B_occupy=20 GB.

(7) Judge whether LEVEL1≦B_occupy≦LEVEL2 (S307).

Here, LEVEL1 is the permissive lower limit of an amount of record candidate programs and is set, for example, to around ⅓ of space remaining when an amount of recorded programs whose delete-protect dates will not be reached within the specific time period (a week in this embodiment) is subtracted from the total capacity of the program data storing area. LEVEL2 is the target amount of record candidate programs and is set, for example, to around ⅔ of the remaining space.

(8) If the above condition is unmet, judge the fixed occupancy amount B_occupy as not being proper, and check whether B_occupy≧LEVEL1 (S308).

(9) If B_occupy≧LEVEL1, reduce the base retention period by a predetermined value (S309). Here, a retention period of each program recorded in the storing unit 104 may be recalculated with the reduced base retention period. Then return to step S301.

(10) If B_occupy<LEVEL1 (i.e. B_occupy<LEVEL2), judge whether every genre in “favorite genre” in the user information has been selected for the most recently selected time period (S310). If there is a genre in “favorite genre” which has not been selected yet, return to step S304 to create a new search criterion by adding the genre to the priority parameter and the time period. For example, if all genres in “favorite genre” have been separately combined with the priority parameter and the time period 20:00˜21:00 but only the genre “drama” has been combined with the priority parameter and the time period 21:00˜22:00, return to step S304 to add another genre to the priority parameter and the time period 21:00˜22:00.

(11) If every genre in “favorite genre” has been added to the priority parameter and the most recently selected time period, judge whether there is a time period in “favorite time period” which has not been selected (S311). If there is no time period which has not been selected, proceed to step S313. If there is a time period which has not been selected, return to step S303 to select the time period.

(12) If LEVEL1≦B_occupy≦LEVEL2 in step S307, judge whether there is a time period in “favorite time period” which has not be selected (S312). If there is no time period which has not been selected, proceed to step S313. Otherwise, return to step S303.

(13) Reveal the search criteria obtained so far to the user (S313).

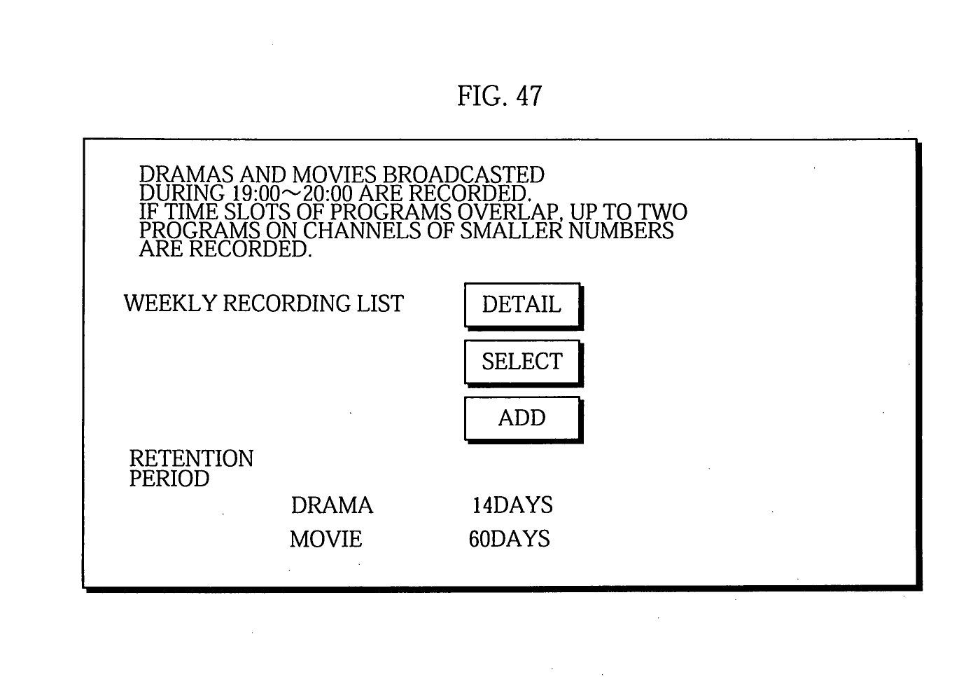

FIG. 47 shows an example of a display which reveals search criteria.

Note that the numbers of tuners and decoders mounted in the program recording apparatus of the present embodiment limit the number of programs which can be simultaneously received to two, as being so stated on the display.

Also displayed are the “detail” button for displaying a list of programs to be automatically recorded during a week ahead, the “select” button for approving the displayed content, and the “add” button for adding other search criteria to the displayed search criteria.

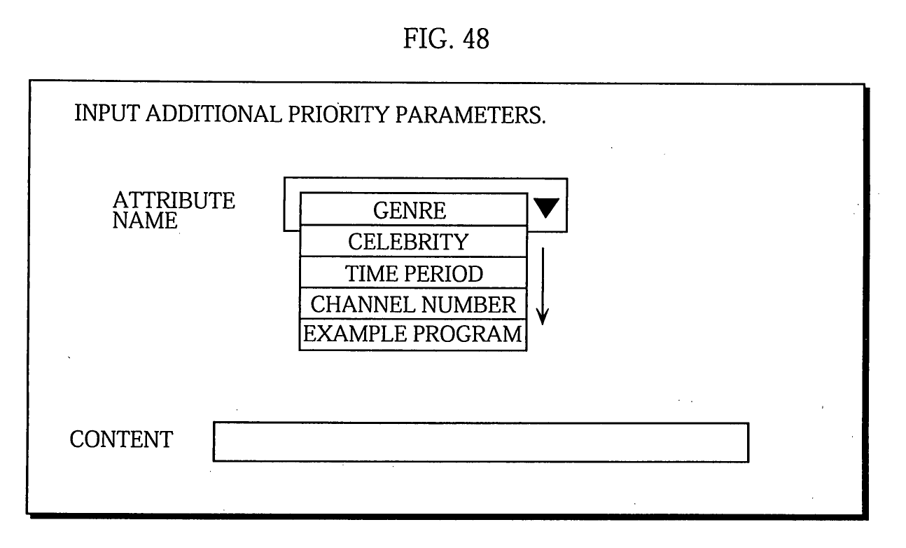

FIG. 48 shows an example of a display for adding priority parameters.

This display urges the user to input attribute names and values of priority parameters. A conventional method is used for this input. For example, the user may directly input in text using the remote control or the like, or may select from a menu of potential attribute names and values.

(14) Judge whether the user has inputted priority parameters (S314). If the user did not input additional priority parameters (i.e. if the user has pressed the “select” button on the display in FIG. 47), end the search criteria setting procedure.

(15) If the user has inputted additional priority parameters, add the priority parameters to “priority parameter” in the user information (S315).

(16) Calculate a fixed occupancy amount based on retention periods of record candidate programs found according to the search criteria obtained as a result of the addition of the user-input search criteria, in the same way as step S306. If the fixed occupancy amount of the record candidate programs exceeds LEVEL2, reduce the base retention period until the fixed occupancy amount becomes the proper amount, and display the search criteria and the genre-specific retention periods (S316).

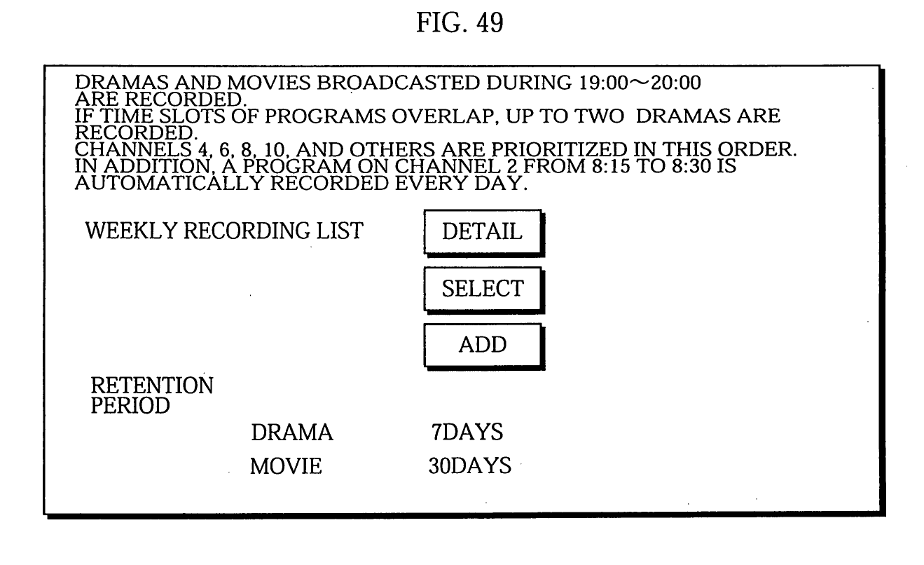

FIG. 49 shows an example of a display showing search criteria after the user has added other search criteria to the search criteria shown in FIG. 47.

As illustrated, to the search criteria shown in FIG. 47 the user has added search criteria which indicate: giving drama higher priority than movie; prioritizing channels 4, 6, 8, 10, and others in this order; and recording a program on channel 2 from 8:15 to 8:30 every day. Since the number of record candidate programs has increased due to the addition of the search criteria, the genre-specific retention periods have been shortened accordingly.

Thus, the program recording apparatus of the seventh embodiment can set search criteria and automatically record programs using the search criteria, based on user preferences shown in user-specified user information, a recording capacity of the program data storing area, and an amount of programs recorded in the program data storing area. Here, genre-specific retention periods are given to programs to be recorded. Since delete-protect dates of recorded programs are displayed, the user can easily know which programs have been recorded and how long they will be retained. Also, without specific user operations the program recording apparatus automatically records programs that meet the user preferences and deletes recorded programs whose delete-protect dates have been reached, with it being possible to record new programs at any time. Here, a delete-protect date of any recorded program can be modified by the user. Also, if the number of record candidate programs that meet the user preferences in a specific period of time increases, the base retention period is reduced to shorten retention periods, so that sufficient space for recording more programs is secured. Accordingly, failures to record user's favorite programs or emergent programs such as feature programs will be significantly reduced.

While in the above embodiment retention periods have been set after a search for record candidate programs, the setting of retention periods may be done at any time before the retention periods are used.

As for the storage form of a delete-protect date of a recorded program, the delete-protect date itself or a combination of a recording date the program and a retention period of the program may be stored, though any other form is possible as long as the delete-protect date is explicitly expressed.

While genre-specific retention periods have been used in the above embodiment, retention periods may vary according to other parameters. For example, a long retention period may be specially given to a program in which the user's favorite celebrity appears, or a certain retention period may be given to a particular program.

A delete-protect date can be displayed in any form as long as it is made explicit to the user. For example, color-coding may be used in such a way that a delete-protect date which will not be reached within a week is blue-colored, a delete-protect date which will be reached within a week is yellow-colored, and a delete-protect date which has already been reached is red-colored.

While in the above embodiment programs whose delete-protect dates were reached have been deleted while maintaining the certain amount of programs in the storing unit 104, programs may be deleted as soon as their delete-protect dates are reached. Also, the automatic deletion procedure may be performed at time intervals longer or shorter than a day.

While the user information has been manually inputted by the user in the above embodiment, the user information may also be automatically set. For example, based on a history of programs viewed by the user, time periods during which the user frequently watched programs and genres preferred by the user may be prioritized and set respectively in “favorite time period” and “favorite genre” in user information. Also, user information which was initially set by the user may be modified according to a history of programs viewed by the user thereafter.

While in the above embodiment a search criterion has been created by first setting a time period and then adding a genre to the time period, the search criterion may instead be created by first setting a genre and then adding a time period to the genre.

While in the above embodiment the user information has shown time periods, genres, and channel numbers, the user information may include any information contained in program information sent from broadcast stations. For instance, celebrities, programs recommended by broadcast stations, and relations between programs may be shown in the user information.

While in the above automatic deletion procedure in automatic recording shown in FIG. 44, the predetermined threshold values have been used to reduce the number of record candidate programs and to modify the search criteria, the present invention is not limited to such. For example, a primary control method may be introduced whereby a difference between a calculation result and a predetermined target level is used for feedback.

While programs whose delete-protect dates were reached have been automatically deleted in the above embodiment, a list of delete candidate programs whose delete-protect dates have been reached may be displayed for the user to determine which of the programs should be deleted.

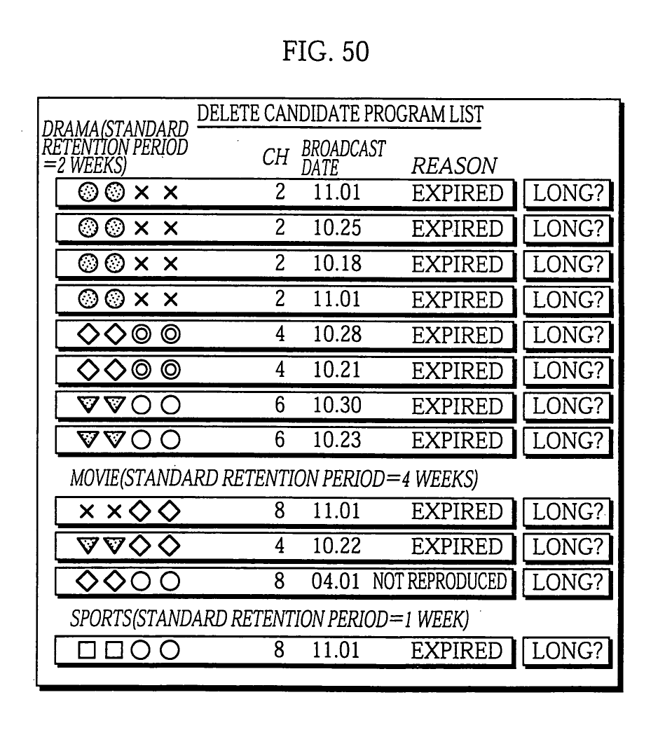

FIG. 50 shows an example of a GUI display showing a list of delete candidate programs.

This list shows a program title, channel number, and broadcast date of each delete candidate program together with a reason why the program can be deleted. In the figure, the reason is either a delete-protect date of the program has been reached or the program has not been reproduced for a long time.

Though the method used in the above embodiment for searching for the programs whose delete-protect dates have been reached may be applied to the search for the delete candidate programs, there is a more convenient method whereby programs with their recording dates are stored separately from genre-specific retention periods beforehand, and when the need for displaying a delete candidate program list arises, a delete-protect date of each recorded program is calculated and a list of programs whose delete-protect dates have been reached is displayed.

On the display shown in FIG. 50, selecting a program has the program deleted, while pressing a “long?” button has a delete-protect date of a program extended by a fixed period of time. Here, a flag may be added to each program to indicate whether an delete-protect date of the program has been extended.

While a delete-protect date has been assigned to each program to be recorded in the above embodiment, the present invention is not limited to such. For example, the program may be recorded together with a set of content information relating to the content of the program such as a genre, a celebrity, and a keyword, wherein combinations between sets of content information and delete conditions which each show a condition of allowing a program to be deleted have been stored in a storing area in advance. This being so, a delete condition corresponding to the set of content information of the program is retrieved from the storing area, and the program is deleted if the delete condition is met.

Also, the automatic deletion procedure may be performed not at regular time intervals (e.g. a day) but every time a new program is going to be recorded.

While each of the first to seventh embodiments has been described as hardware such as a logic IC in this specification, the present invention can also be implemented by software. By storing the software on computer-readable storage mediums such as CD-ROMs, any of production, utilization, transference, lending, importation, and proposition for transference/lending with regard to the present invention is possible as in the case of the hardware.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1-12. (Cancel)

13. A broadcast program recording apparatus for receiving programs to be recorded and recording the received programs into a fixed storing unit, the broadcast program recording apparatus comprising:
time assigning means for assigning, to a received program, a delete-protect time before which the program cannot be automatically deleted;
recording means for recording the program to which the delete-protect time has been assigned, into the fixed storing unit; and
automatic deleting means for automatically deleting the recorded program whose delete-protect time has been reached.

14. The broadcast program recording apparatus of claim 13, wherein the time assigning means includes:
retention period information storing means for storing a set of retention period information about a retention period during which the program cannot be automatically deleted; and
time generating means for generating the delete-protect time by adding the retention period shown by the set of retention period information to a time when the program is recorded.

15. The broadcast program recording apparatus of claim 14, further comprising
content information storing means for prestoring a plurality of sets of content information which each relate to a content of a program,
wherein the retention period information storing means stores a plurality of sets of retention period information corresponding to the plurality of sets of content information, and
wherein the time generating means searches the retention period information storing means for the set of retention period information corresponding to a set of content information relating to a content of the received program, to generate the delete-protect time.

16. The broadcast program recording apparatus of claim 15,
wherein the plurality of sets of contention information each show any of a genre, a celebrity, and a keyword of the program.

17. The broadcast program recording apparatus of claim 15,
wherein the plurality of sets of retention period information in the retention period information storing means each show a coefficient which is to be multiplied with a base retention period,
wherein the time assigning means further includes:
base retention period storing means for storing the base retention period; and
base retention period changing means for changing the base retention period depending on an available space in the fixed storing unit, and
wherein the time generating means generates the delete-protect time using the retention period obtained by multiplying the base retention period by a coefficient shown by the set of retention period information.

18. The broadcast program recording apparatus of claim 13,
wherein the automatic deleting means controls an available space in the fixed storing unit when a new program is recorded, by automatically deleting the recorded program whose delete-protect time has been reached.

19. The broadcast program recording apparatus of claim 13, further comprising:
displaying means for displaying the delete-protect time of the recorded program together with information identifying the recorded program; and
change receiving means for receiving an instruction to change the displayed delete-protect time from a user.

20. A broadcast program recording apparatus for receiving programs to be recorded and recording the received programs into a fixed storing unit, the broadcast program recording apparatus comprising:
content information acquiring means for acquiring a set of content information relating to a content of a received program;
delete condition storing means for storing delete conditions corresponding to sets of content information, each of the delete conditions showing a condition for allowing a program to be automatically deleted;
content information assigning means for assigning the set of content information acquired by the content information acquiring means to the received program;
recording means for recording the received program to which the set of content information has been assigned, into the fixed storing unit; and
automatic deleting means for retrieving, from the delete condition storing means, a delete condition corresponding to the set of content information assigned to the recorded program, and automatically deleting the recorded program when the retrieved delete condition is satisfied.

21. A broadcast program recording apparatus for receiving programs to be recorded and recording the received programs into a fixed storing unit, the broadcast program recording apparatus comprising:
time assigning means for assigning, to a received program, a delete-protect time before which the program cannot be deleted;
recording means for recording the program to which the delete-protect time has been assigned, into the fixed storing unit;
delete candidate program searching means for searching the fixed storing unit for delete candidate programs whose delete-protect times have been reached;
displaying means for displaying a list of the delete candidate programs;
delete instruction receiving means for receiving from a user a selection of a delete candidate program which should be deleted among the delete candidate programs in the displayed list; and
deleting means for deleting the delete candidate program selected by the user.

22-26. (Canceled)

27. A computer-readable storing medium storing a broadcast program recording program for receiving programs to be recorded and recording the received programs into a fixed storing unit, the broadcast program recording program comprising:
a time assigning step for assigning, to a received program, a delete-protect time before which the program cannot be automatically deleted;
a recording step for recording the program to which the delete-protect time has been assigned, into the fixed storing unit; and
an automatic deleting step for automatically deleting the recorded program whose delete-protect time has been reached.

28. A computer-readable storing medium storing a broadcast program recording program for receiving programs to be recorded and recording the received programs into a fixed storing unit, in a broadcast program recording apparatus equipped with a delete condition storing unit storing delete conditions which correspond to sets of content information and which each show a condition for allowing a program to be automatically deleted, the broadcast program recording program comprising:
a content information acquiring step for acquiring a set of content information relating to a content of a received program;
a content information assigning step for assigning the set of content information acquired by the content information acquiring step to the received program;
a recording step for recording the received program to which the set of content information has been assigned, into the fixed storing unit; and
an automatic deleting step for retrieving, from the delete condition storing unit, a delete condition corresponding to the set of content information assigned to the recorded program, and automatically deleting the recorded program when the retrieved delete condition is satisfied.

29. A computer-readable storing medium storing a broadcast program recording program for receiving programs to be recorded and recording the received programs into a fixed storing unit, the broadcast program recording program comprising:
a time assigning step for assigning, to a received program, a delete-protect time before which the program cannot be deleted;
a recording step for recording the program to which the delete-protect time has been assigned, into the fixed storing unit;
a delete candidate program searching step for searching the fixed storing unit for delete candidate programs whose delete-protect times have been reached;
a displaying step for displaying a list of the delete candidate programs;
a delete instruction receiving step for receiving from a user a selection of a delete candidate program which should be deleted among the delete candidate programs in the displayed list; and
a deleting step for deleting the delete candidate program selected by the user.

30-31. (Canceled)
